(19) United States
(12) Patent Application Publication
(10) Pub. No.: US 2025/0321451 A1
(43) Pub. Date: Oct. 16, 2025

(54) LIQUID CRYSTAL LIGHT DEFLECTOR AND DRIVING METHOD OF LIQUID CRYSTAL LIGHT DEFLECTOR

(71) Applicant: Shanghai AVIC Optoelectronics Co., Ltd., Shangha (CN)

(72) Inventors: Yukie KEICHO, Kawasaki (JP); Tetsushi SATO, Kawasaki (JP)

(73) Assignee: Shanghai AVIC Optoelectronics Co., Ltd., Shanghai (CN)

(21) Appl. No.: 19/174,051

(22) Filed: Apr. 9, 2025

(30) Foreign Application Priority Data
Apr. 11, 2024 (JP) 2024-063975
Feb. 5, 2025 (JP) 2025-017247

(51) Int. Cl. G02F 1/1337; G02F 1/1343

(52) U.S. Cl. CPC G02F 1/133776; G02F 1/134309; G02F 2201/121

(57) ABSTRACT

A liquid crystal light deflector includes a liquid-crystal light deflection panel and a controller. The liquid-crystal light deflection panel includes liquid crystals and electrodes to apply an electric field to the liquid crystals. The controller applies, to the liquid crystals, a predetermined electric field for driving the liquid crystals toward the direction orthogonal to the initial alignment direction of the liquid crystals, and thus causes the liquid-crystal light deflection panel to transition to the first state causing deflection. The controller applies, to the liquid crystals, a uniform electric field for driving at least some of the liquid crystals toward the direction orthogonal to the initial alignment direction, and thus causes the liquid-crystal light deflection panel to transition from the first state to the second state causing no deflection.

### CROSS-REFERENCE TO RELATED APPLICATIONS

This application claims the benefit of Japanese Patent Application No. 2024-063975, filed on Apr. 11, 2024, and Japanese Patent Application No. 2025-17247, filed on Feb. 5, 2025, of which the entirety of the disclosures is incorporated by reference herein.

### FIELD OF THE INVENTION

This application relates to a liquid crystal light deflector and a driving method of a liquid crystal light deflector.

### BACKGROUND OF THE INVENTION

Liquid crystal light deflectors have been known that cause deflection of light by means of a change in alignment of liquid crystals, and serve as lenses, prisms, and other mechanisms against the light. For example, Japanese Patent No. 5536004 discloses a liquid crystal lens including two electrode structures (first and second electrode structures) disposed apart from each other, and a liquid crystal layer disposed between the two electrode structures.

In Japanese Patent No. 5536004, the first electrode structure includes multiple first linear electrodes extending in a first extending direction, and the second electrode structure includes multiple second linear electrodes extending in a second extending direction that intersects the first extending direction and a planar electrode. When the first linear electrodes have a voltage difference from the second linear electrodes and the planar electrode, this voltage difference generates a first electric field. The first electric field changes the direction of alignment in the liquid crystal layer, and thus brings the liquid crystal layer into the lensing mode. When the planar electrode has a voltage difference from the second linear electrodes, this voltage difference generates a second electric field. The second electric field changes the direction of alignment in the liquid crystal layer back to the initial arrangement direction, and does not bring the liquid crystal layer into the lensing mode.

The application of the second electric field to the liquid crystal layer changes the direction of alignment in the liquid crystal layer back to the initial arrangement direction in Japanese Patent No. 5536004. This configuration can reduce the time required by the liquid crystal molecules in the liquid crystal layer to return to the non-lensing mode (initial alignment state).

The liquid crystal lens disclosed in Japanese Patent No. 5536004 necessarily includes three types of electrodes, that is, the first linear electrodes, the second linear electrodes, and the planar electrode, in order to generate the first and second electric fields. The liquid crystal lens thus has a complicated electrode configuration, and a complicated configuration of a drive circuit for driving the liquid crystal lens.

The second electric field, which is generated between the planar electrode and the second linear electrodes and changes the liquid crystal layer back to the initial arrangement direction, is a lateral electric field in Japanese Patent No. 5536004. The generation of the second electric field (lateral electric field) between the planar electrode and the second linear electrodes, however, accompanies generation of a vertical electric field (electric field in the thickness direction of the liquid crystal layer) between the second linear electrodes and the first linear electrodes opposed to the second linear electrodes. This vertical electric field disrupts the alignment in the liquid crystal layer during a change of the liquid crystal layer back to the initial arrangement direction. The vertical electric field disrupts the distribution of refractive indexes of the liquid crystal layer and causes non-uniform optical properties of the liquid crystal lens disclosed in Japanese Patent No. 5536004 during a change of the liquid crystal lens (liquid crystal molecules) back to the non-lensing mode.

### SUMMARY OF THE INVENTION

A liquid crystal light deflector according to a first aspect includes:
a liquid-crystal light deflection panel including
   a first substrate through which light enters,
   a second substrate opposed to the first substrate,
   liquid crystals held between the first substrate and the second substrate, and
   electrodes to apply an electric field to the liquid crystals; and
a controller to control deflection of the light by the liquid-crystal light deflection panel, wherein
the controller applies a predetermined electric field to the liquid crystals and thus causes the liquid-crystal light deflection panel to transition to a first state causing the deflection, the predetermined electric field driving the liquid crystals toward a direction orthogonal to an initial alignment direction of the liquid crystals, the predetermined electric field generating a distribution of refractive indexes in the liquid crystals in accordance with levels of the deflection, and
the controller applies a uniform electric field to the liquid crystals and thus causes the liquid-crystal light deflection panel to transition from the first state to a second state causing no deflection, the uniform electric field driving at least some of the liquid crystals toward the direction orthogonal to the initial alignment direction.

A driving method of a liquid crystal light deflector according to a second aspect involves:
applying a predetermined electric field to liquid crystals of a liquid-crystal light deflection panel and thus causing the liquid-crystal light deflection panel to transition to a first state causing deflection, the predetermined electric field driving the liquid crystals toward a direction orthogonal to an initial alignment direction of the liquid crystals, the predetermined electric field generating a distribution of refractive indexes in the liquid crystals in accordance with levels of the deflection; and
applying a uniform electric field to the liquid crystals and thus causing the liquid-crystal light deflection panel to transition from the first state to a second state causing no deflection, the uniform electric field driving at least some of the liquid crystals toward the direction orthogonal to the initial alignment direction.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a schematic view of a liquid crystal light deflector, a liquid crystal display panel, and a display device according to Embodiment 1;

FIG. 2 is a sectional view of the liquid-crystal light deflection panel illustrated in FIG. 1 taken along the line A-A;

FIG. 3 is a plan view of first electrodes according to Embodiment 1;

FIG. 4 is a plan view of a second electrode according to Embodiment 1;

FIG. 5 illustrates a hardware configuration of a controller according to Embodiment 1;

FIG. 6 is a schematic view of the alignment of liquid crystals in the initial state according to Embodiment 1;

FIG. 7 illustrates a distribution of refractive indexes for linearly polarized light in the initial state according to Embodiment 1;

FIG. 8 is a schematic view of the alignment of liquid crystals in the first state according to Embodiment 1;

FIG. 9 illustrates electric potentials of the first electrodes according to Embodiment 1;

FIG. 10 illustrates a distribution of refractive indexes for linearly polarized light in the first state according to Embodiment 1;

FIG. 11 is a schematic view of the alignment of liquid crystals in the second state according to Embodiment 1;

FIG. 12 illustrates a distribution of refractive indexes for linearly polarized light in the second state according to Embodiment 1;

FIG. 13 is a schematic view for illustrating disrupted alignment of liquid crystals according to Embodiment 1;

FIG. 14 illustrates electric potentials of the first electrodes according to Embodiment 1 for application of a predetermined electric field to liquid crystals;

FIG. 15 illustrates a variation in distribution of refractive indexes for linearly polarized light according to Embodiment 1;

FIG. 16 illustrates a variation in distribution of refractive indexes for linearly polarized light according to Comparative Example 1;

FIG. 17 illustrates a relationship between a voltage applied to liquid crystals and a response time according to Embodiment 1;

FIG. 18 illustrates a variation in distribution of refractive indexes for linearly polarized light according to Embodiment 1;

FIG. 19 is a flowchart illustrating a driving process of the liquid crystal light deflector according to Embodiment 1;

FIG. 20 is a schematic view of the alignment of liquid crystals in the initial state according to Embodiment 2;

FIG. 21 illustrates a distribution of refractive indexes for linearly polarized light in the initial state according to Embodiment 2;

FIG. 22 is a schematic view of the alignment of liquid crystals in the first state according to Embodiment 2;

FIG. 23 illustrates a distribution of refractive indexes for linearly polarized light in the first state according to Embodiment 2;

FIG. 24 is a schematic view of the alignment of liquid crystals in the second state according to Embodiment 2;

FIG. 25 illustrates a distribution of refractive indexes for linearly polarized light in the second state according to Embodiment 2;

FIG. 26 is a schematic view of the alignment of liquid crystals in the initial state according to Embodiment 3;

FIG. 27 illustrates a distribution of refractive indexes for linearly polarized light in the initial state according to Embodiment 3;

FIG. 28 is a schematic view of the alignment of liquid crystals in the first state according to Embodiment 3;

FIG. 29 illustrates a distribution of refractive indexes for linearly polarized light in the first state according to Embodiment 3;

FIG. 30 is a plan view of second electrodes according to Embodiment 4;

FIG. 31 illustrates a distribution of refractive indexes for linearly polarized light in the initial state according to Embodiment 4;

FIG. 32 is a schematic view of the alignment of liquid crystals in the first state according to Embodiment 4;

FIG. 33 illustrates electric potentials of the second electrodes according to Embodiment 4;

FIG. 34 illustrates a distribution of refractive indexes for linearly polarized light in the first state according to Embodiment 4;

FIG. 35 illustrates a distribution of refractive indexes for linearly polarized light in the second state according to Embodiment 4;

FIG. 36 is a schematic view of the alignment of liquid crystals in the first state according to Embodiment 5;

FIG. 37 illustrates electric potentials of first electrodes according to Embodiment 5;

FIG. 38 illustrates a distribution of refractive indexes for linearly polarized light in the first state according to Embodiment 5;

FIG. 39 is a sectional view of a liquid-crystal light deflection panel according to Embodiment 6;

FIG. 40 is a plan view of electrodes according to Embodiment 6;

FIG. 41 is a schematic view of the alignment of liquid crystals in the first state according to Embodiment 6;

FIG. 42 is a schematic view of the alignment of liquid crystals in the second state according to Embodiment 6;

FIG. 43 is a flowchart illustrating a driving process of a liquid crystal light deflector according to Embodiment 7;

FIG. 44 illustrates electric potentials of first electrodes according to Embodiment 8;

FIG. 45 illustrates electric potentials of the first electrodes according to Embodiment 8 for application of a first electric field to liquid crystals;

FIG. 46 illustrates a variation in distribution of refractive indexes for linearly polarized light according to Embodiment 8;

FIG. 47 illustrates a variation in distribution of refractive indexes for linearly polarized light according to Comparative Example 2;

FIG. 48 is a schematic view of the alignment of liquid crystals in the second state according to Embodiment 8;

FIG. 49 illustrates a variation in distribution of refractive indexes for linearly polarized light according to Embodiment 8;

FIG. 50 illustrates a variation in distribution of refractive indexes for linearly polarized light according to Comparative Example 3;

FIG. 51 is a flowchart illustrating a driving process of a liquid crystal light deflector according to Embodiment 8;

FIG. 52 illustrates a relationship between an elapsed time and electric potentials of first electrodes according to Embodiment 9, and a magnitude relationship among the electric potentials of each first electrode at individual elapsed times;

FIG. 53 is a flowchart illustrating a driving process of a liquid crystal light deflector according to Embodiment 9;

FIG. 54 is a plan view of first electrodes according to a modification;

FIG. 55 is a plan view of first electrodes according to another modification;

FIG. 56 is a schematic view of the alignment of liquid crystals in the second state according to another modification;

FIG. 57 illustrates a relationship between an elapsed time and a period of application of a first electric field according to another modification; and

FIG. 58 illustrates a relationship between an elapsed time, electric potentials of first electrodes, and a period of application of a first electric field according to another modification.

### DETAILED DESCRIPTION OF THE INVENTION

A liquid crystal light deflector according to some embodiments is described below with reference to the accompanying drawings.

### Embodiment 1

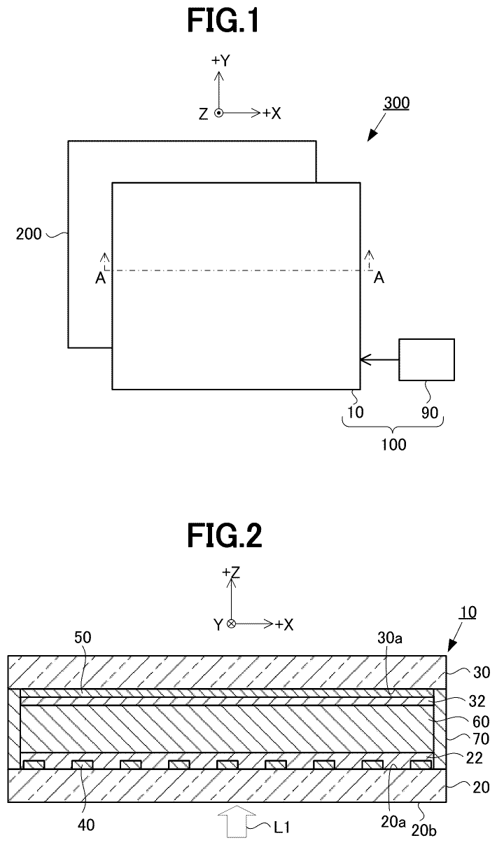

The following describes a liquid crystal light deflector 100 according to an embodiment, with reference to FIGS. 1 to 19. As illustrated in FIG. 1, the liquid crystal light deflector 100 includes a liquid-crystal light deflection panel 10 and a controller 90. The liquid-crystal light deflection panel 10 deflects light, because of a change in the alignment of liquid crystals 60, which is described below. The liquid-crystal light deflection panel 10 serves as a lenticular lens, for example. The controller 90 controls the deflection of the liquid-crystal light deflection panel 10.

For example, the liquid-crystal light deflection panel 10 is disposed on the side of a liquid crystal display panel 200 adjacent to the screen. The liquid crystal light deflector 100 and the liquid crystal display panel 200 constitute a display device 300 that displays two-dimensional and three-dimensional images. This specification refers to the rightward direction of the liquid-crystal light deflection panel 10 in FIG. 1 (on the plane of the figure) as “+X direction”, the upward direction (on the plane of the figure) as “+Y direction”, and the direction perpendicular to the +X and +Y directions (extending from the plane of the figure toward an observer) as “+Z direction”, in order to facilitate an understanding.

The liquid-crystal light deflection panel 10 transitions between the initial state, the first state, and the second state. In the initial state, the liquid-crystal light deflection panel 10 includes the liquid crystals 60 in the initial alignment state, has an even distribution of refractive indexes, and does not deflect light (linearly polarized light). In the first state, the liquid-crystal light deflection panel 10 includes the liquid crystals 60 aligned in a predetermined state by receiving a predetermined electric field (voltage) for driving the liquid crystals 60 toward the direction orthogonal to the initial alignment direction, has a distribution of refractive indexes varying in a predetermined cycle, and deflects the light. In the second state, the liquid-crystal light deflection panel 10 includes the liquid crystals 60 uniformly aligned by receiving a uniform electric field (voltage) for driving at least some of the liquid crystals 60 toward the direction (identical to the driving direction for a transition from the initial state to the first state) orthogonal to the initial alignment direction, has an even distribution of refractive indexes, and does not deflect the light. In the first state in this embodiment, the liquid-crystal light deflection panel 10 serves as a lenticular lens array including cylindrical lenses extending in the Y direction and arranged in the X direction, because of the distribution of refractive indexes of the liquid-crystal light deflection panel 10 varying in the X direction in a predetermined cycle. The initial alignment direction of the liquid crystals 60 indicates the direction of alignment of the liquid crystals 60 (liquid crystal molecules) in the initial alignment state (under no application of an electric field) in a plan view or sectional view.

The liquid-crystal light deflection panel 10 in the initial state or second state does not serve as a lenticular lens array, and thus allows the display device 300 to display a two-dimensional image. In contrast, the liquid-crystal light deflection panel 10 in the first state serves as a lenticular lens array, and thus allows the display device 300 to display a three-dimensional image.

The liquid-crystal light deflection panel 10 has a specific configuration described below. As illustrated in FIG. 2, the liquid-crystal light deflection panel 10 includes a first substrate 20, a second substrate 30, multiple first electrodes 40, a second electrode 50, and the liquid crystals 60. The first substrate 20 and the second substrate 30 hold the liquid crystals 60 therebetween. The first electrodes 40 and the second electrode 50 are opposed to each other and apply an electric field (voltage) to the liquid crystals 60.

The first substrate 20 of the liquid-crystal light deflection panel 10 transmits visible light. The first substrate 20 is a glass substrate having a flat-plate shape, for example. The first substrate 20 has a first main surface 20a adjacent to the liquid crystals 60, which is provided with the first electrodes 40. The first substrate 20 is also provided with an alignment film 22. The alignment film 22 covers the first main surface 20a of the first substrate 20 and the first electrodes 40, and aligns the liquid crystals 60 in a predetermined direction. The alignment film 22 is a polyimide alignment film prepared through an alignment treatment, for example.

The first substrate 20 has a second main surface 20b opposite to the first main surface 20a. The second main surface 20b receives linearly polarized light L1 from the −Z side. In this embodiment, the linearly polarized light L1 has a direction of polarization in the Y direction.

The second substrate 30 of the liquid-crystal light deflection panel 10 transmits visible light. The second substrate 30 is a glass substrate having a flat-plate shape, for example. The second substrate 30 is opposed to the first substrate 20, and bonded to the first substrate 20 by a sealing member 70. The second substrate 30 has a first main surface 30a adjacent to the liquid crystals 60, which is provided with the second electrode 50. The second substrate 30 is also provided with an alignment film 32. The alignment film 32 covers the second electrode 50, and aligns the liquid crystals 60 in a predetermined direction. The alignment film 32 is also a polyimide alignment film prepared through an alignment treatment.

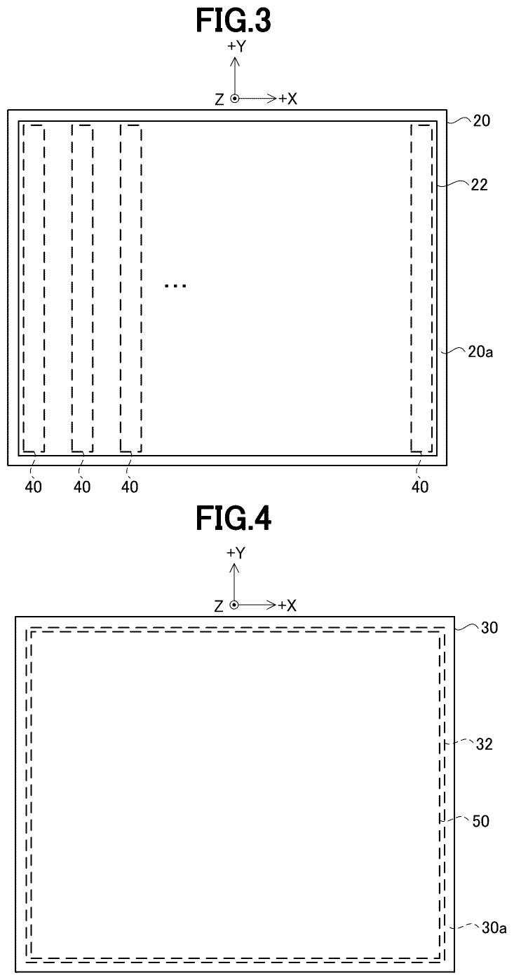

As illustrated in FIGS. 2 and 3, the first electrodes 40 of the liquid-crystal light deflection panel 10 are mounted on the first main surface 20a of the first substrate 20. The first electrodes 40 are each a linear electrode having a rectangular shape and extending in the Y direction. The first electrodes 40 are arranged at a predetermined interval in the X direction. The first electrodes 40 are individually connected to the controller 90 via wires, which are not illustrated. The first electrodes 40 each include a conductive film that transmits visible light. The first electrodes 40 are made of indium tin oxide (ITO), for example. In this embodiment, the Y direction corresponds to a predetermined first direction.

As illustrated in FIGS. 2 and 4, the second electrode 50 of the liquid-crystal light deflection panel 10 is mounted on the first main surface 30a of the second substrate 30. The second electrode 50 has a rectangular shape and is opposed to the first electrodes 40. The second electrode 50 is connected to the controller 90 via a wire, which is not illustrated. The second electrode 50 includes a conductive film that transmits visible light. The second electrode 50 is made of ITO, for example.

The liquid crystals 60 of the liquid-crystal light deflection panel 10 are held between the first substrate 20 and the second substrate 30. The liquid crystals 60 are nematic liquid crystals of positive dielectric anisotropy, for example. The liquid crystals 60 in the initial alignment state are aligned in the Y direction due to the alignment films 22 and 32.

The controller 90 controls the electric field (voltage) to be applied to the liquid crystals 60 via the first electrodes 40 and the second electrode 50, and thus induces a transition of the state of the liquid-crystal light deflection panel 10. In this embodiment, the controller 90 causes the liquid-crystal light deflection panel 10 to transition from the initial state, in which the liquid-crystal light deflection panel 10 includes the liquid crystals 60 in the initial alignment state, has an even distribution of refractive indexes, and does not deflect the linearly polarized light L1, to the first state, in which the liquid-crystal light deflection panel 10 includes the liquid crystals 60 aligned in the predetermined state by receiving the predetermined electric field for driving the liquid crystals 60 toward the direction orthogonal to the initial alignment direction, has a distribution of refractive indexes varying in a predetermined cycle, and deflects the linearly polarized light L1. The predetermined electric field (voltage) drives the liquid crystals 60 toward the direction orthogonal to the initial alignment direction of the liquid crystals 60, and thus generates a distribution of refractive indexes in the liquid crystals 60 in accordance with the levels of deflection.

Furthermore, the controller 90 causes the liquid-crystal light deflection panel 10 to transition from the first state to the second state, in which the liquid-crystal light deflection panel 10 includes the liquid crystals 60 uniformly aligned by receiving the uniform electric field for driving at least some of the liquid crystals 60 toward the direction orthogonal to the initial alignment direction, has an even distribution of refractive indexes, and does not deflect the linearly polarized light L1. The direction orthogonal to the initial alignment direction toward which the liquid crystals 60 are driven for a transition from the initial state to the first state is identical to the direction orthogonal to the initial alignment direction toward which at least some of the liquid crystals 60 are driven for a transition from the first state to the second state. In addition, the controller 90 causes the liquid-crystal light deflection panel 10 to transition from the second state to the initial state. These controls of the controller 90 and the operations of the liquid-crystal light deflection panel 10 are described in detail below.

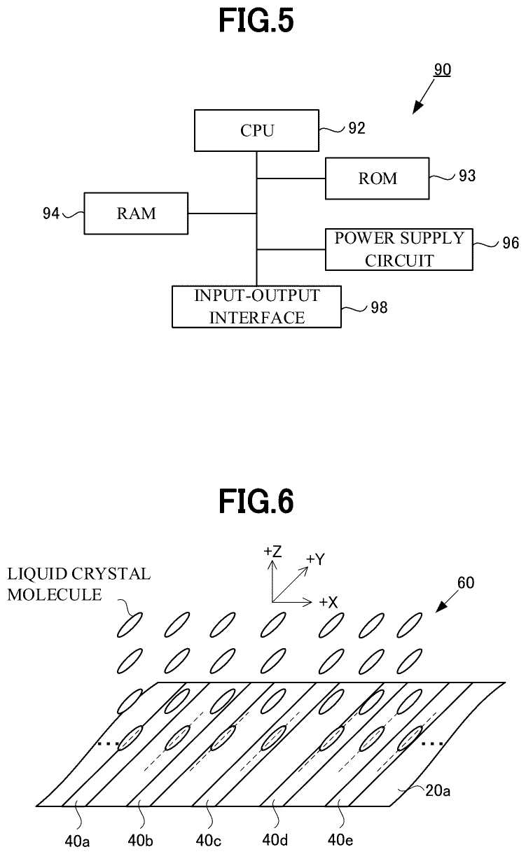

FIG. 5 illustrates a hardware configuration of the controller 90. The controller 90 includes a central processing unit (CPU) 92, a read only memory (ROM) 93, a random access memory (RAM) 94, a power supply circuit 96, and an input-output interface 98, for example. The CPU 92 executes programs stored in the ROM 93. The ROM 93 stores programs and data, for example. The RAM 94 stores data. The power supply circuit 96 is connected to the first electrodes 40 and the second electrode 50, and applies an electric field to the liquid crystals 60 via the first electrodes 40 and the second electrode 50. The input-output interface 98 transmits and receives signals to and from external apparatuses. The functions of the controller 90 are performed when the CPU 92 executes the programs stored in the ROM 93.

The controls of the controller 90 and the operations of the liquid-crystal light deflection panel 10 are described below. The liquid-crystal light deflection panel 10 serves as a lenticular lens array, because of a change in the alignment of the liquid crystals 60.

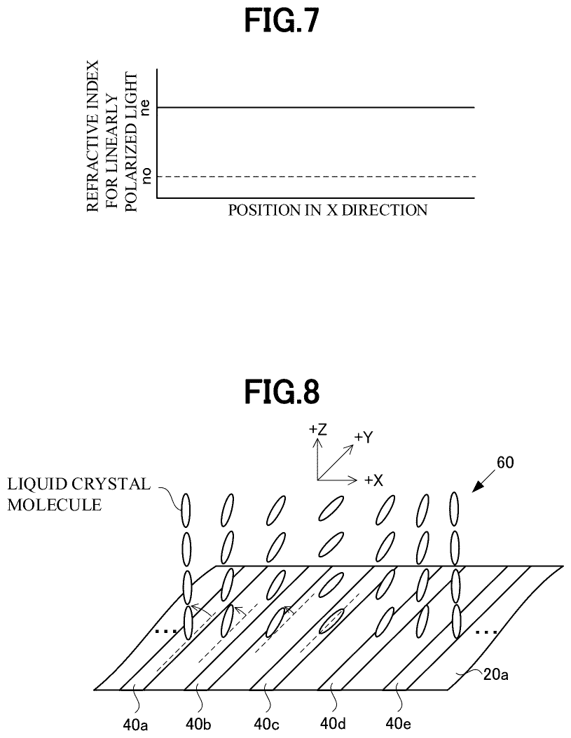

The following first describes the initial state of the liquid-crystal light deflection panel 10. In the initial state of the liquid-crystal light deflection panel 10, the controller 90 adjusts the electric potentials of the first electrodes 40 and the electric potential of the second electrode 50 to the same potential (for example, ground potential), and thus applies no electric field to the liquid crystals 60, thereby maintaining the liquid crystals 60 in the initial alignment state (alignment in the Y direction) illustrated in FIG. 6. The liquid-crystal light deflection panel 10 in this state has an even distribution of refractive indexes for the linearly polarized light L1 with the polarization direction in the Y direction (that is, the refractive indexes for the linearly polarized light L1 are all equal to the extraordinary refractive index ne of the liquid crystals 60) as illustrated in FIG. 7. The liquid-crystal light deflection panel 10 thus does not serve as a lenticular lens array. The value “no” illustrated in FIG. 7 indicates the ordinary refractive index of the liquid crystals 60.

In order to cause the liquid-crystal light deflection panel 10 to serve as a lenticular lens array, the controller 90 controls the electric potentials (voltages) of the first electrodes 40 and the electric potential (voltage) of the second electrode 50, and applies, to the liquid crystals 60, the predetermined electric field for driving the liquid crystals 60 toward the direction orthogonal to the initial alignment direction. The controller 90 thus drives the liquid crystals 60 toward the direction orthogonal to the initial alignment direction, and aligns the liquid crystals 60 in the predetermined state. This control induces a transition to the first state causing deflection of the linearly polarized light L1. The predetermined electric field drives the liquid crystals 60 toward the direction orthogonal to the initial alignment direction of the liquid crystals 60, and generates a distribution of refractive indexes in the liquid crystals 60 in accordance with the levels of deflection.

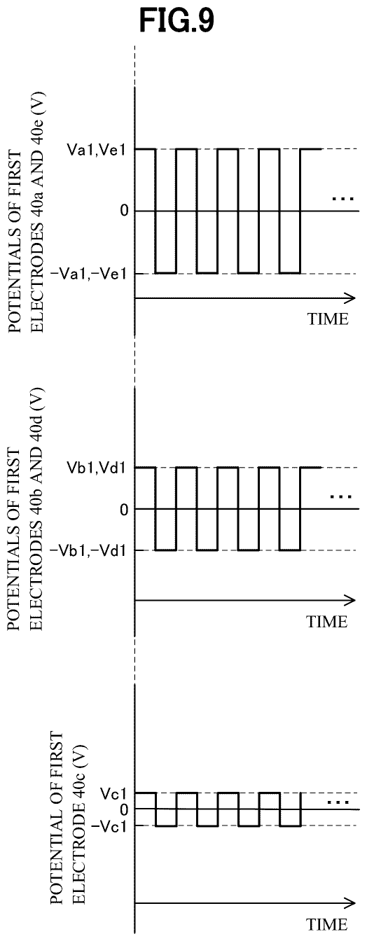

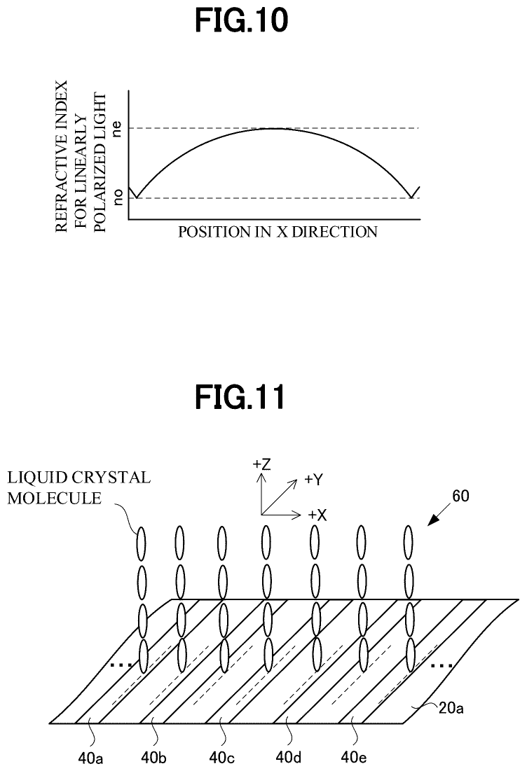

Specifically, the controller 90 adjusts the electric potential of the second electrode 50 to the ground potential, and adjusts the electric potentials of the first electrodes 40a and 40e illustrated in FIG. 8 to the electric potentials ±Va1 and ±Ve1 for generating a distribution of refractive indexes in the liquid crystals 60 in accordance with the levels of deflection (FIG. 9). The controller 90 also adjusts the electric potentials of the first electrodes 40b and 40d to the electric potentials ±Vb1 and ±Vd1 for generating a distribution of refractive indexes in the liquid crystals 60 in accordance with the levels of deflection, and adjusts the electric potential of the first electrode 40c to the electric potential ±Vc1 for generating a distribution of refractive indexes in the liquid crystals 60 in accordance with the levels of deflection (FIG. 9). The values of the electric potentials ±Va1 to ±Ve1 are defined to satisfy the expression: |±Va1|=|±Ve1|>|±Vb1|=|±Vd1|>|±Vc1|. These adjusted electric potentials lead to application of the predetermined electric field to the liquid crystals 60, and thus drive the liquid crystals 60 toward the +Z direction. As illustrated in FIG. 8, the angle of elevation of the liquid crystal molecules relative to the first main surface 20a of the first substrate 20 toward the +Z direction increases from the first electrode 40c to the first electrode 40a, and the angle of elevation of the liquid crystal molecules relative to the first main surface 20a of the first substrate 20 toward the +Z direction increases from the first electrode 40c to the first electrode 40e. In this case, the distribution of refractive indexes of the liquid-crystal light deflection panel 10 for the linearly polarized light L1 with the polarization direction in the Y direction has quadratic variations repeated in a predetermined cycle in the X direction, as illustrated in FIG. 10. The liquid-crystal light deflection panel 10 thus serves as a lenticular lens array extending in the Y direction and arranged in the X direction. FIG. 8 does not illustrate the liquid crystal molecules located near the interfaces of the alignment films 22 and 32 and less responsive to an electric field. The subsequent figures also do not illustrate such liquid crystal molecules located near the interfaces of the alignment films 22 and 32.

In order to cause the liquid-crystal light deflection panel 10 to transition from the state serving as a lenticular lens array to the state not serving as a lenticular lens array, the controller 90 controls the electric potentials (voltages) of the first electrodes 40 and the electric potential (voltage) of the second electrode 50, and thus applies, to the liquid crystals 60, the uniform electric field (voltage) for driving the liquid crystals 60 toward the direction identical to the direction in which the liquid crystals 60 are driven to induce a transition from the initial state to the first state. This uniform electric filed drives at least some of the liquid crystals 60 toward the direction (orthogonal to the initial alignment direction) identical to the direction in which the liquid crystals 60 are driven to induce a transition from the initial state to the first state, and thus causes the liquid-crystal light deflection panel 10 to transition to the second state causing no deflection of the linearly polarized light L1.

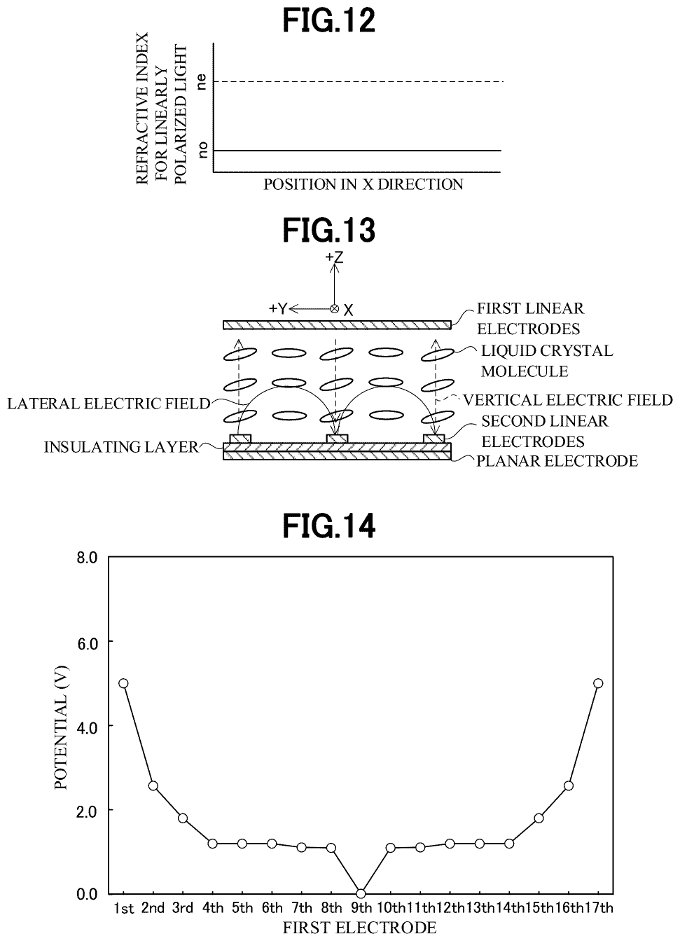

Specifically, the controller 90 adjusts the electric potential of the second electrode 50 to the ground potential, and adjusts the electric potentials of the first electrodes 40a to 40e to the same potential (for example, the electric potential for aligning the liquid crystals 60 in the Z direction), in order to apply the uniform electric field to the liquid crystals 60. These adjusted electric potentials drive at least some of the liquid crystals 60 (located in the region between the first electrodes 40a and 40e in a plan view) toward the +Z direction, and align the liquid crystal molecules in the Z direction, for example, and thus bring the liquid crystals 60 into a uniform alignment state (FIG. 11). This state provides an even distribution of refractive indexes of the liquid-crystal light deflection panel 10 for the linearly polarized light L1 (that is, the refractive indexes for the linearly polarized light L1 are all equal to the ordinary refractive index no of the liquid crystals 60) as illustrated in FIG. 12. The liquid-crystal light deflection panel 10 thus does not serve as a lenticular lens array.

In this embodiment, the controller 90 applies the uniform electric field to the liquid crystals 60 and drives the liquid crystals 60 toward the direction (identical to the driving direction for a transition from the initial state to the first state) orthogonal to the initial alignment direction, and thus causes the liquid-crystal light deflection panel 10 to transition, from the first state including the liquid crystals 60 aligned in the predetermined state and causing deflection, to the second state causing no deflection. The liquid crystal light deflector 100 according to the embodiment can thus achieve a shorter response time required for a transition from the state causing deflection to the state causing no deflection, than the response time in the case where the liquid-crystal light deflection panel 10 is caused to transition from the first state causing deflection back to the initial state causing no deflection without application of an electric field.

The controller 90 applies the uniform electric field to the liquid crystals 60, drives the liquid crystals 60 toward the direction orthogonal to the initial alignment direction, and thus uniformly aligns the liquid crystals 60. This configuration can avoid disrupted alignment of the liquid crystals 60 and thus prevent the non-uniform optical properties of the liquid-crystal light deflection panel 10, in a transition of the liquid-crystal light deflection panel 10 from the state causing deflection to the state causing no deflection.

For example, FIG. 13 illustrates a liquid crystal lens like that disclosed in Japanese Patent No. 5536004, which includes first linear electrodes, second linear electrodes, and a planar electrode. In this liquid crystal lens, a vertical electric field is generated as well as a lateral electric field during a change of liquid crystal molecules in a liquid crystal layer back to the initial arrangement direction, and disrupts the alignment in the liquid crystal molecules in the liquid crystal layer. Such disrupted alignment in the liquid crystal layer occurs because the liquid crystal molecules in the regions (between the second linear electrodes) mainly affected by the lateral electric field have a different angle of elevation toward the +Z direction, from that of the liquid crystal molecules in the regions (above the second linear electrodes) mainly affected by the vertical electric field. The disrupted alignment results in the non-uniform optical properties of the liquid crystal lens. The non-uniform optical properties resulting from the disrupted alignment in the liquid crystal layer (alignment of the liquid crystals 60) can be avoided by the liquid crystal light deflector 100.

In this embodiment, the electrodes (first electrodes 40 and the second electrode 50) for applying an electric field to the liquid crystals 60 to cause the liquid-crystal light deflection panel 10 to transition to the state causing deflection are identical to the electrodes (first electrodes 40 and the second electrode 50) for applying an electric field to the liquid crystals 60 to cause the liquid-crystal light deflection panel 10 to transition to the state causing no deflection. This structure can simplify the electrode configuration of the liquid-crystal light deflection panel 10 and the configuration of the controller 90.

The controller 90 in the embodiment may control the electric potentials of the first electrodes 40 and the electric potential of the second electrode 50 and stop application of the uniform electric field to the liquid crystals 60, and thus cause the liquid-crystal light deflection panel 10 to transition from the second state causing no deflection to the initial state causing no deflection. The refractive indexes of the liquid-crystal light deflection panel 10 for the linearly polarized light L1, which are equal to the ordinary refractive index no of the liquid crystals 60 uniformly aligned in the second state, uniformly shift to the extraordinary refractive index ne in response to a change in alignment of the liquid crystals 60 during a transition of the liquid-crystal light deflection panel 10 from the second state to the initial state. The liquid-crystal light deflection panel 10 during or after the transition does not cause deflection either.

The following specifically describes a response time τoff required for a transition from the state causing deflection (state serving as a lenticular lens) to the state causing no deflection (state not serving as a lenticular lens) and a voltage Vs to be applied to the liquid crystals 60, focusing on an exemplary single lenticular lens (lens pitch: 300 μm) made of 17 first electrodes 40 arranged in the X direction. In this example, the refractive index anisotropy Δn of the liquid crystals 60 is 0.2 (extraordinary refractive index ne: 1.71, ordinary refractive index no: 1.51, 589 nm), the dielectric anisotropy Δs of the liquid crystals 60 is 8.9, the thickness of the layer of the liquid crystals 60 is 100 μm, and the width of the first electrodes 40 is 6.25 μm. The description below is based on simulations performed by the liquid crystal simulator “LCD Master” available from SHINTECH Co., Ltd.

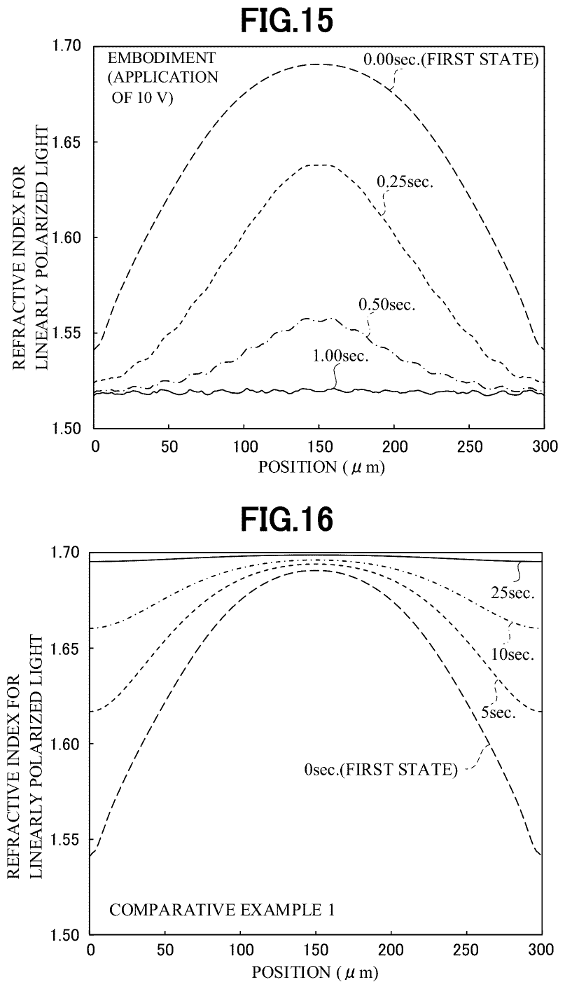

The response time τoff is first described. In this example, the controller 90 adjusted the electric potential of the second electrode 50 to the ground potential, adjusted the electric potentials of the 1st to 17th first electrodes 40 to the electric potentials illustrated in FIG. 14 in the order from the negative side of the X direction, and thus applied the predetermined electric field to the liquid crystals 60, thereby achieving the first state causing deflection. After the achievement of the first state, the controller 90 adjusted the electric potentials of the 1st to 17th first electrodes 40 to 10 V (that is, applied a voltage Vs of 10 V to the liquid crystals 60), and thus drove at least some of the liquid crystals 60 toward the +Z direction, thereby achieving the second state causing no deflection. The transition from the first state to the second state accompanied a variation in distribution of refractive indexes for the linearly polarized light L1, as illustrated in FIG. 15. The response time τoff of the liquid crystal light deflector 100 required for a transition from the state causing deflection to the state causing no deflection was one second, assuming that the response time τoff is the time from the start of a transition from the state causing deflection until the difference between the maximum and minimum values of refractive indexes for the linearly polarized light L1 reaches 0.005.

In contrast, in a comparative example (hereinafter referred to as “Comparative Example 1”), the controller 90 adjusted the electric potentials of the 1st to 17th first electrodes 40 to the ground potential, and thus achieved the initial state causing no deflection, after the achievement of the first state causing deflection as in the above-described example. In Comparative Example 1, the transition to the initial state accompanied a variation in distribution of refractive indexes for the linearly polarized light L1, as illustrated in FIG. 16. Comparative Example 1 provided a response time τoff of 25 seconds.

As described above, the controller 90 causes the liquid-crystal light deflection panel 10 to transition from the first state causing deflection to the second state causing no deflection, and can thus reduce the response time τoff required for a transition from the state causing deflection to the state causing no deflection.

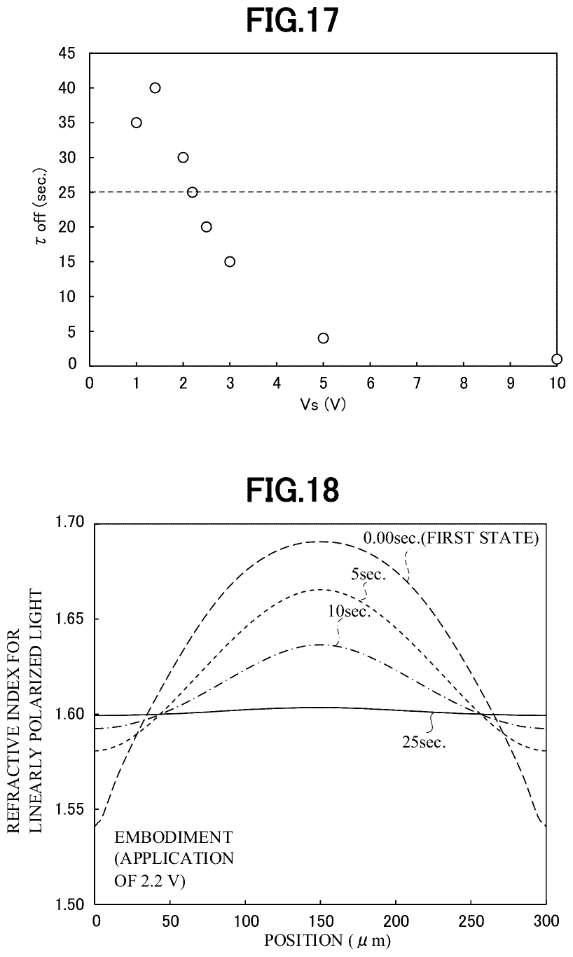

The voltage Vs is then described, which is applied to the liquid crystals 60 to induce a transition from the first state causing deflection to the second state causing no deflection. FIG. 17 illustrates a relationship between the voltage Vs and the response time τoff of the liquid crystal light deflector 100. As illustrated in FIG. 17, the voltage Vs of at least 2.2 V can achieve a shorter response time τoff of the liquid crystal light deflector 100 than the response time τoff in Comparative Example 1, under the above-mentioned conditions of the liquid crystals 60, the first electrodes 40, and the other components. In the case where the voltage Vs of 2.2 V is applied (specifically, the electric potential of the second electrode 50 is adjusted to the ground potential, and the electric potentials of the 1st to 17th first electrodes 40 are adjusted to 2.2 V), the distribution of refractive indexes for the linearly polarized light L1 varies as illustrated in FIG. 18.

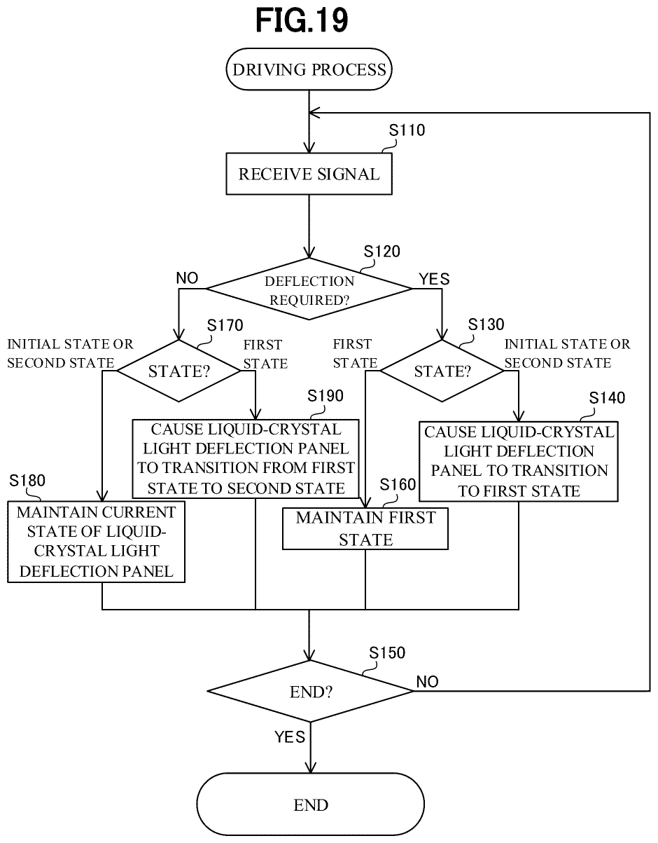

The following describes a driving process of the liquid crystal light deflector 100 with reference to FIG. 19. In response to electric power supply, the controller 90 of the liquid crystal light deflector 100 resets the liquid-crystal light deflection panel 10 to the initial state. The controller 90 then receives a signal indicating requirement of deflection, from an external apparatus (for example, a controller of the liquid crystal display panel 200) (Step S110).

The controller 90 then identifies the received signal (Step S120). When the received signal indicates that “deflection is required” (Step S120; YES), the controller 90 identifies the state of the liquid-crystal light deflection panel 10 before reception of the signal (Step S130).

When the liquid-crystal light deflection panel 10 before reception of the signal is in the initial state or second state (Step S130: initial state or second state), the controller 90 applies, to the liquid crystals 60 of the liquid-crystal light deflection panel 10, the predetermined electric field for driving the liquid crystals 60 toward the direction orthogonal to the initial alignment direction, and thus causes the liquid-crystal light deflection panel 10 to transition from the initial state or second state to the first state causing deflection of the linearly polarized light L1 (state serving as a lenticular lens) (Step S140). The predetermined electric field drives the liquid crystals 60 toward the direction orthogonal to the initial alignment direction of the liquid crystals 60, and generates a distribution of refractive indexes in the liquid crystals 60 in accordance with the levels of deflection. When receiving a signal indicating termination of the driving process from the external apparatus (Step S150; YES), the controller 90 terminates the driving process of the liquid crystal light deflector 100. In contrast, when receiving no signal indicating termination of the driving process from the external apparatus (Step S150; NO), the controller 90 returns the driving process of the liquid crystal light deflector 100 to the step (Step S110) of receiving a signal indicating requirement of deflection, and maintains the current first state of the liquid-crystal light deflection panel 10 until reception of a subsequent signal.

When the liquid-crystal light deflection panel 10 before reception of the signal is in the first state (Step S130: first state), the controller 90 maintains the current first state of the liquid-crystal light deflection panel 10 (Step S160). When receiving a signal indicating termination of the driving process from the external apparatus (Step S150; YES), the controller 90 terminates the driving process of the liquid crystal light deflector 100. In contrast, when receiving no signal indicating termination of the driving process from the external apparatus (Step S150; NO), the controller 90 returns the driving process of the liquid crystal light deflector 100 to the step (Step S110) of receiving a signal indicating requirement of deflection, and maintains the current first state of the liquid-crystal light deflection panel 10 until reception of a subsequent signal.

When the received signal indicates that “deflection is not required” (Step S120; NO), the controller 90 identifies the state of the liquid-crystal light deflection panel 10 before reception of the signal (Step S170). When the liquid-crystal light deflection panel 10 before reception of the signal is in the initial state or second state (Step S170: initial state or second state), the controller 90 maintains the current state (initial state or second state) of the liquid-crystal light deflection panel 10 (Step S180). When receiving a signal indicating termination of the driving process from the external apparatus (Step S150; YES), the controller 90 terminates the driving process of the liquid crystal light deflector 100. In contrast, when receiving no signal indicating termination of the driving process from the external apparatus (Step S150; NO), the controller 90 returns the driving process of the liquid crystal light deflector 100 to the step (Step S110) of receiving a signal indicating requirement of deflection, and maintains the current state of the liquid-crystal light deflection panel 10 until reception of a subsequent signal.

When the liquid-crystal light deflection panel 10 before reception of the signal is in the first state (Step S170: first state), the controller 90 controls the electric potentials of the first electrodes 40 and the electric potential of the second electrode 50, and thus applies, to the liquid crystals 60, the uniform electric field for driving the liquid crystals 60 toward the direction (orthogonal to the initial alignment direction) identical to the direction in which the liquid crystals 60 are driven to induce a transition from the initial state to the first state. The controller 90 thus causes the liquid-crystal light deflection panel 10 to transition from the first state to the second state causing no deflection of the linearly polarized light L1 (that is, the state not serving as a lenticular lens) (Step S190). When receiving a signal indicating termination of the driving process from the external apparatus (Step S150; YES), the controller 90 terminates the driving process of the liquid crystal light deflector 100. In contrast, when receiving no signal indicating termination of the driving process from the external apparatus (Step S150; NO), the controller 90 returns the driving process of the liquid crystal light deflector 100 to the step (Step S110) of receiving a signal indicating requirement of deflection, and maintains the current second state of the liquid-crystal light deflection panel 10 until reception of a subsequent signal.

In the driving process of the liquid crystal light deflector 100, the controller 90 applies the uniform electric field to the liquid crystals 60, drives at least some of the liquid crystals 60 toward the direction (identical to the driving direction for a transition from the initial state to the first state) orthogonal to the initial alignment direction, and thus causes the liquid-crystal light deflection panel 10 to transition from the first state causing deflection to the second state causing no deflection. The driving process of the liquid crystal light deflector 100 according to the embodiment can also achieve a shorter response time required for a transition from the state causing deflection to the state causing no deflection, than the response time in the case of transition of the liquid-crystal light deflection panel 10 from the first state causing deflection back to the initial state causing no deflection.

The controller 90 applies the uniform electric field to the liquid crystals 60, drives at least some of the liquid crystals 60 toward the direction orthogonal to the initial alignment direction, and thus uniformly aligns the liquid crystals 60. The driving process of the liquid crystal light deflector 100 can thus avoid disrupted alignment of the liquid crystals 60 in a transition of the liquid-crystal light deflection panel 10 from the state causing deflection to the state causing no deflection. The driving process of the liquid crystal light deflector 100 can thus prevent the non-uniform optical properties of the liquid-crystal light deflection panel 10.

As described above, the liquid crystal light deflector 100 can reduce the response time required for a transition from the state causing deflection to the state causing no deflection. The liquid crystal light deflector 100 can avoid disrupted alignment of the liquid crystals 60 in a transition of the liquid-crystal light deflection panel 10 from the state causing deflection to the state causing no deflection, and thus prevent the non-uniform optical properties of the liquid-crystal light deflection panel 10. The liquid crystal light deflector 100 can achieve a simpler electrode configuration of the liquid-crystal light deflection panel 10 and a simpler configuration of the controller 90.

The driving process of the liquid crystal light deflector 100 can reduce the response time required for a transition from the state causing deflection to the state causing no deflection. The driving process of the liquid crystal light deflector 100 can prevent the non-uniform optical properties of the liquid-crystal light deflection panel 10 in a transition of the liquid-crystal light deflection panel 10 from the state causing deflection to the state causing no deflection.

### Embodiment 2

In Embodiment 1, the liquid crystals 60 of the liquid-crystal light deflection panel 10 are nematic liquid crystals of positive dielectric anisotropy. The liquid crystals 60 may also be nematic liquid crystals of negative dielectric anisotropy.

The liquid-crystal light deflection panel 10 in this embodiment includes liquid crystals 60, which are nematic liquid crystals of negative dielectric anisotropy. The liquid crystal light deflector 100 according to the embodiment has the same configurations as the liquid crystal light deflector 100 according to Embodiment 1, except for the alignment of the liquid crystals 60 and the distribution of refractive indexes. The description focuses on the alignment of the liquid crystals 60 and the distribution of refractive indexes of the liquid-crystal light deflection panel 10.

The liquid crystals 60 of the liquid-crystal light deflection panel 10 in the embodiment are nematic liquid crystals of negative dielectric anisotropy, and aligned in the Z direction because of the alignment films 22 and 32.

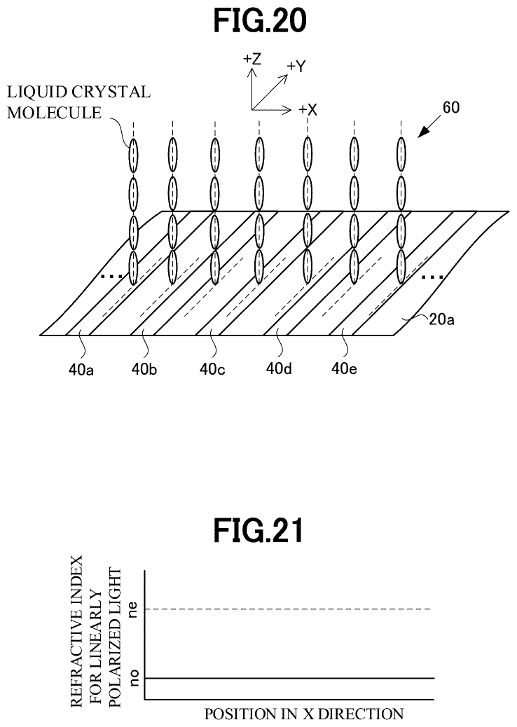

In the initial state of the liquid-crystal light deflection panel 10 in the embodiment, the controller 90 adjusts the electric potentials of the first electrodes 40 and the electric potential of the second electrode 50 to the same potential, and thus applies no electric field to the liquid crystals 60, thereby maintaining the liquid crystals 60 in the initial alignment state (alignment in the Z direction) illustrated in FIG. 20. This state provides an even distribution of refractive indexes of the liquid-crystal light deflection panel 10 for the linearly polarized light L1 with the polarization direction in the Y direction (specifically, the refractive indexes for the linearly polarized light L1 are all equal to the ordinary refractive index no of the liquid crystals 60) as illustrated in FIG. 21. The liquid-crystal light deflection panel 10 thus does not serve as a lenticular lens array.

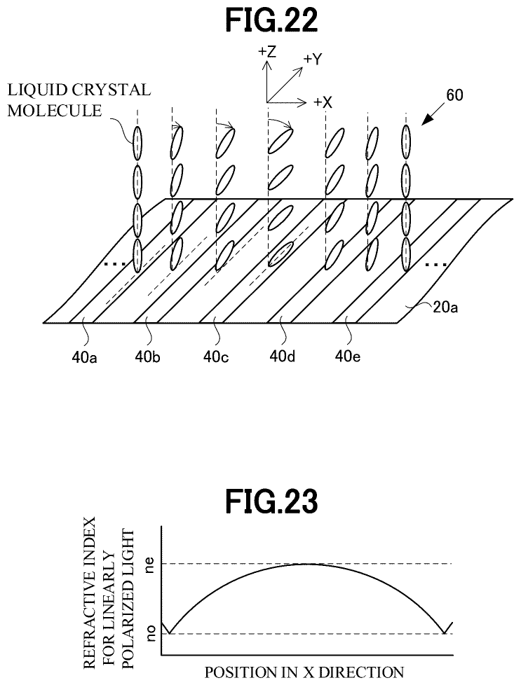

In the first state of the liquid-crystal light deflection panel 10 in the embodiment, the controller 90 applies a predetermined electric field to the liquid crystals 60, and thus aligns the liquid crystals 60 in a predetermined state, as in Embodiment 1. Specifically, the controller 90 adjusts the electric potential of the second electrode 50 to the ground potential, and adjusts the electric potentials of the first electrodes 40a and 40e illustrated in FIG. 22 to the electric potentials ±Va1 and ±Ve1 for generating a distribution of refractive indexes in the liquid crystals 60 in accordance with the levels of deflection. The controller 90 adjusts the electric potentials of the first electrodes 40b and 40d to the electric potentials ±Vb1 and ±Vd1 for generating a distribution of refractive indexes in the liquid crystals 60 in accordance with the levels of deflection, and adjusts the electric potential of the first electrode 40c to the electric potential ±Vc1 for generating a distribution of refractive indexes in the liquid crystals 60 in accordance with the levels of deflection. The values of the electric potentials ±Va1 to ±Ve1 are defined to satisfy the expression: |±Vc1|>|±Vb1|=|±Vd1|>|±Va1|=|±Ve1|. These adjusted electric potentials lead to application of the predetermined electric field to the liquid crystals 60, and thus drive the liquid crystals 60 toward the +Y direction. As illustrated in FIG. 22, the inclination of the liquid crystal molecules relative to the +Z direction increases from the first electrode 40a to the first electrode 40c, and the inclination of the liquid crystal molecules relative to the +Z direction increases from the first electrode 40e to the first electrode 40c. In this case, the distribution of refractive indexes of the liquid-crystal light deflection panel 10 for the linearly polarized light L1 with the polarization direction in the Y direction has variations repeated in a predetermined cycle in the X direction, as illustrated in FIG. 23. The liquid-crystal light deflection panel 10 thus serves as a lenticular lens array extending in the Y direction and arranged in the X direction.

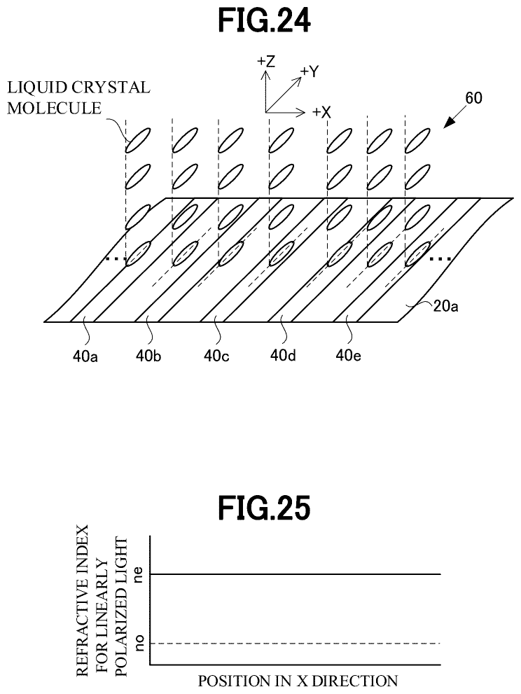

In the second state of the liquid-crystal light deflection panel 10 in the embodiment, the controller 90 applies, to the liquid crystals 60, a uniform electric field for driving the liquid crystals 60 toward the direction identical to the direction in which the liquid crystals 60 are driven to induce a transition from the initial state to the first state, as in Embodiment 1. The uniform electric field drives at least some of the liquid crystals 60 toward the direction (orthogonal to the initial alignment direction) identical to the driving direction for a transition from the initial state to the first state. Specifically, the controller 90 adjusts the electric potential of the second electrode 50 to the ground potential, and adjusts the electric potentials of the first electrodes 40a to 40e to the same potential (for example, electric potential for aligning the liquid crystals 60 in the Y direction). These adjusted electric potentials drive at least some of the liquid crystals 60 toward the +Y direction, align the liquid crystal molecules in the Y direction, for example, and bring the liquid crystals 60 into the uniform alignment state (FIG. 24). This state provides an even distribution of refractive indexes of the liquid-crystal light deflection panel 10 for the linearly polarized light L1 (specifically, the refractive indexes for the linearly polarized light L1 are all equal to the extraordinary refractive index ne of the liquid crystals 60) as illustrated in FIG. 25. The liquid-crystal light deflection panel 10 thus does not serve as a lenticular lens array.

In this embodiment, the controller 90 applies the uniform electric field to the liquid crystals 60, drives at least some of the liquid crystals 60 toward the direction (identical to the driving direction for a transition from the initial state to the first state) orthogonal to the initial alignment direction, and thus causes the liquid-crystal light deflection panel 10 to transition from the first state causing deflection to the second state causing no deflection. The liquid crystal light deflector 100 can thus reduce the response time required for a transition from the state causing deflection to the state causing no deflection. Furthermore, the controller 90 applies the uniform electric field to the liquid crystals 60, drives at least some of the liquid crystals 60 toward the direction orthogonal to the initial alignment direction, and thus uniformly aligns the liquid crystals 60. The liquid crystal light deflector 100 can thus avoid the non-uniform optical properties of the liquid-crystal light deflection panel 10. The liquid crystal light deflector 100 can achieve a simpler electrode configuration of the liquid-crystal light deflection panel 10 and a simpler configuration of the controller 90.

### Embodiment 3

In Embodiment 1, the liquid crystals 60 of the liquid-crystal light deflection panel 10 are aligned in the Y direction. The liquid crystals 60 of the liquid-crystal light deflection panel 10 may also be aligned in a twisted nematic (TN) configuration.

The liquid crystal light deflector 100 according to the embodiment has the same configurations as the liquid crystal light deflector 100 according to Embodiment 1, except for the alignment of the liquid crystals 60 and the distribution of refractive indexes of the liquid-crystal light deflection panel 10. The description focuses on the alignment of the liquid crystals 60 and the distribution of refractive indexes of the liquid-crystal light deflection panel 10.

The liquid crystals 60 of the liquid-crystal light deflection panel 10 in the embodiment are nematic liquid crystals of positive dielectric anisotropy, and provide 90° TN alignment because of the alignment films 22 and 32. In this embodiment, the alignment film 22 aligns the liquid crystals 60 in the Y direction, and the alignment film 32 aligns the liquid crystals 60 in the X direction.

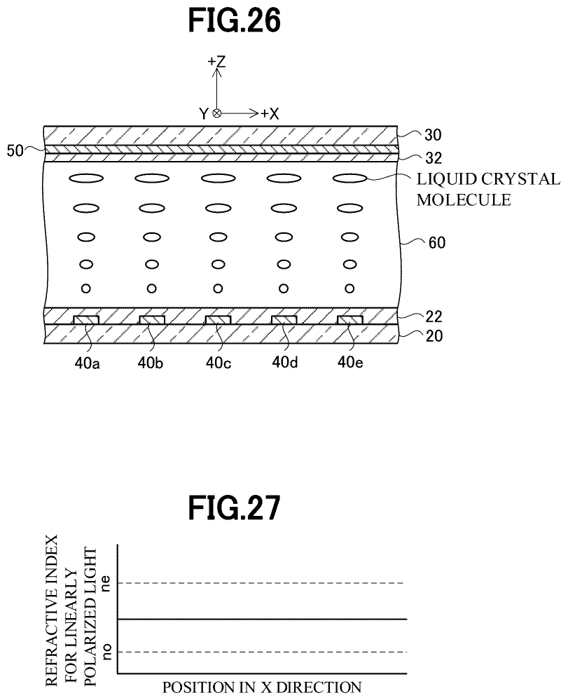

In the initial state of the liquid-crystal light deflection panel 10 in the embodiment, the controller 90 adjusts the electric potentials of the first electrodes 40 and the electric potential of the second electrode 50 to the same potential, and thus applies no electric field to the liquid crystals 60, thereby maintaining the liquid crystals 60 in the initial alignment state (TN alignment) illustrated in FIG. 26. This state provides an even distribution of refractive indexes of the liquid-crystal light deflection panel 10 for the linearly polarized light L1 with the polarization direction in the Y direction (specifically, the refractive indexes for the linearly polarized light L1 are all equal to a certain value between the ordinary refractive index no and the extraordinary refractive index ne of the liquid crystals 60) as illustrated in FIG. 27. The liquid-crystal light deflection panel 10 thus does not serve as a lenticular lens array.

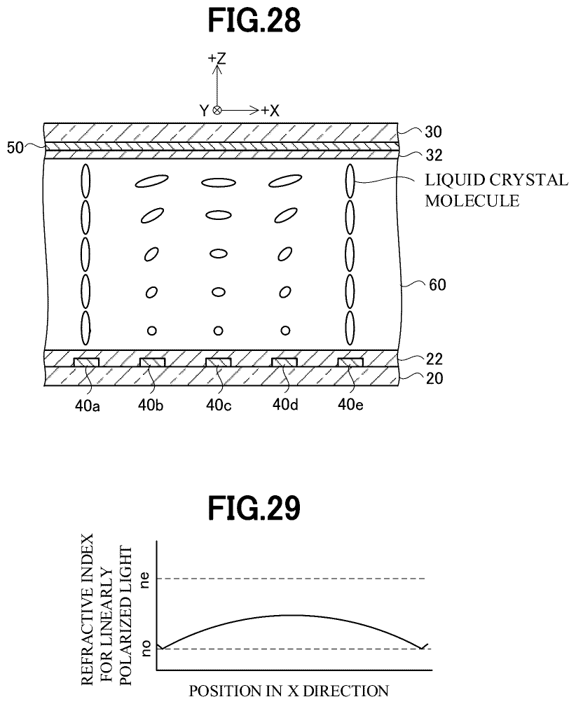

In the first state of the liquid-crystal light deflection panel 10 in the embodiment, the controller 90 applies a predetermined electric field to the liquid crystals 60, and thus aligns the liquid crystals 60 in a predetermined state, as in Embodiment 1. Specifically, the controller 90 adjusts the electric potential of the second electrode 50 to the ground potential, and adjusts the electric potentials of the first electrodes 40a and 40e illustrated in FIG. 28 to the electric potentials ±Va1 and ±Ve1 for generating a distribution of refractive indexes in the liquid crystals 60 in accordance with the levels of deflection. The controller 90 adjusts the electric potentials of the first electrodes 40b and 40d to the electric potentials ±Vb1 and ±Vd1 for generating a distribution of refractive indexes in the liquid crystals 60 in accordance with the levels of deflection, and adjusts the electric potential of the first electrode 40c to the electric potential ±Vc1 for generating a distribution of refractive indexes in the liquid crystals 60 in accordance with the levels of deflection. The electric potentials ±Va1 to ±Ve1 are defined to satisfy the expression: |±Va1|=|±Ve1|>|±Vb1|=|±Vd1|>|±Vc1|. These adjusted electric potentials lead to application of the predetermined electric field to the liquid crystals 60, and thus drive the liquid crystals 60 toward the +Z direction. As illustrated in FIG. 28, the angle of twist of the liquid crystals 60 decreases from the first electrode 40c to the first electrode 40a, and the angle of twist of the liquid crystals 60 decreases from the first electrode 40c to the first electrode 40e. In this case, the distribution of refractive indexes of the liquid-crystal light deflection panel 10 for the linearly polarized light L1 with the polarization direction in the Y direction has variations repeated in a predetermined cycle in the X direction, as illustrated in FIG. 29. The liquid-crystal light deflection panel 10 thus serves as a lenticular lens array extending in the Y direction and arranged in the X direction.

In the second state of the liquid-crystal light deflection panel 10 in the embodiment, the controller 90 applies, to the liquid crystals 60, a uniform electric field for driving the liquid crystals 60 toward the direction identical to the direction in which the liquid crystals 60 are driven to induce a transition from the initial state to the first state, as in Embodiment 1. The uniform electric field drives at least some of the liquid crystals 60 toward the direction (orthogonal to the initial alignment direction) identical to the driving direction for a transition from the initial state to the first state. Specifically, the controller 90 adjusts the electric potential of the second electrode 50 to the ground potential, and adjusts the electric potentials of the first electrodes 40a to 40e to the same potential (for example, electric potential for aligning the liquid crystals 60 in the Z direction). These adjusted electric potentials drive at least some of the liquid crystals 60 toward the +Z direction, align the liquid crystal molecules in the Z direction, for example, and bring the liquid crystals 60 into the uniform alignment state, as in the second state in Embodiment 1 (FIG. 11). This state provides an even distribution of refractive indexes of the liquid-crystal light deflection panel 10 for the linearly polarized light L1 (specifically, the refractive indexes for the linearly polarized light L1 are all equal to the ordinary refractive index no of the liquid crystals 60) as illustrated in FIG. 12. The liquid-crystal light deflection panel 10 thus does not serve as a lenticular lens array.

The liquid crystal light deflector 100 according to the embodiment can also reduce the response time required for a transition from the state causing deflection to the state causing no deflection, as in Embodiments 1 and 2. The liquid crystal light deflector 100 can avoid the non-uniform optical properties of the liquid-crystal light deflection panel 10. The liquid crystal light deflector 100 can achieve a simpler electrode configuration of the liquid-crystal light deflection panel 10 and a simpler configuration of the controller 90.

### Embodiment 4

In Embodiment 1, the single second electrode 50 is mounted on the first main surface 30a of the second substrate 30 and has a rectangular shape. The second electrode 50 may be replaced with multiple linear electrodes mounted on the first main surface 30a of the second substrate 30 and extending in a direction intersecting the first electrodes 40.

The liquid-crystal light deflection panel 10 in this embodiment serves as a lenticular lens array extending in the Y direction and arranged in the X direction, like the liquid-crystal light deflection panel 10 in Embodiment 1. The liquid-crystal light deflection panel 10 in this embodiment also serves as a lenticular lens array extending in the X direction and arranged in the Y direction. This embodiment differs from Embodiment 1 in the configurations of the second electrodes 50 of the liquid-crystal light deflection panel 10 and the deflection of the liquid-crystal light deflection panel 10. The other configurations of the liquid crystal light deflector 100 according to the embodiment are identical to those in Embodiment 1. The description focuses on the second electrodes 50 and the deflection.

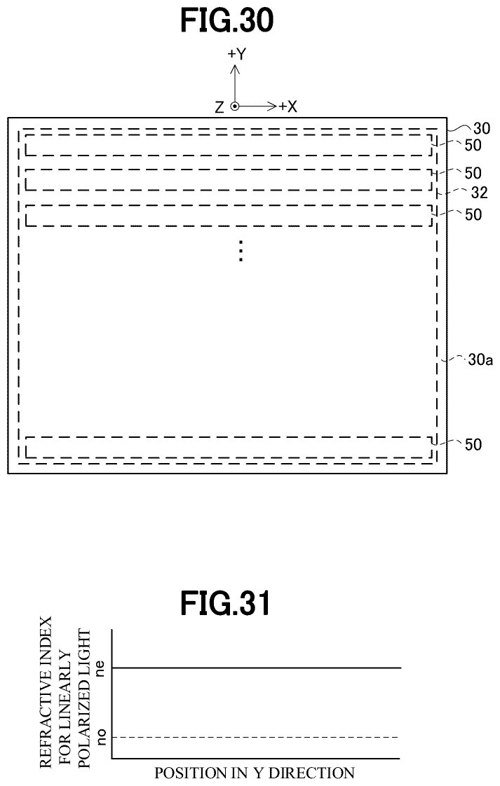

As illustrated in FIG. 30, the second electrodes 50 in the embodiment are multiple linear electrodes mounted on the first main surface 30a of the second substrate 30 and extending in the X direction intersecting the first electrodes 40. The second electrodes 50 each have a rectangular shape and extend in the X direction. The second electrodes 50 are arranged at a predetermined interval in the Y direction. The other configurations of the second electrodes 50 in the embodiment are identical to those of the first electrodes 40 in Embodiment 1.

In an exemplary case where the liquid-crystal light deflection panel 10 in this embodiment serves as a lenticular lens array extending in the Y direction and arranged in the X direction, the liquid crystal light deflector 100 according to the embodiment operates like the liquid crystal light deflector 100 according to Embodiment 1. The description focuses on another exemplary case where the liquid-crystal light deflection panel 10 in the embodiment serves as a lenticular lens array extending in the X direction and arranged in the Y direction.

The initial state of the liquid-crystal light deflection panel 10 in the embodiment is identical to the initial state of the liquid-crystal light deflection panel 10 in Embodiment 1 (FIG. 6). The controller 90 adjusts the electric potentials of the first electrodes 40 and the electric potentials of the second electrodes 50 to the same potential, and thus applies no electric field to the liquid crystals 60, thereby maintaining the liquid crystals 60 in the initial alignment state (alignment in the Y direction). This state provides an even distribution of refractive indexes of the liquid-crystal light deflection panel 10 for the linearly polarized light L1 with the polarization direction in the Y direction (specifically, the refractive indexes for the linearly polarized light L1 are all equal to the extraordinary refractive index ne of the liquid crystals 60) as illustrated in FIG. 31. The liquid-crystal light deflection panel 10 thus does not serve as a lenticular lens array.

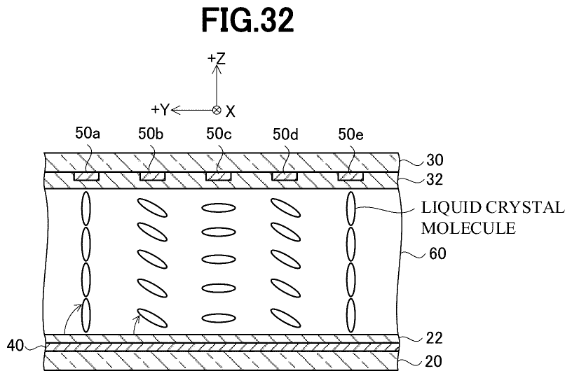

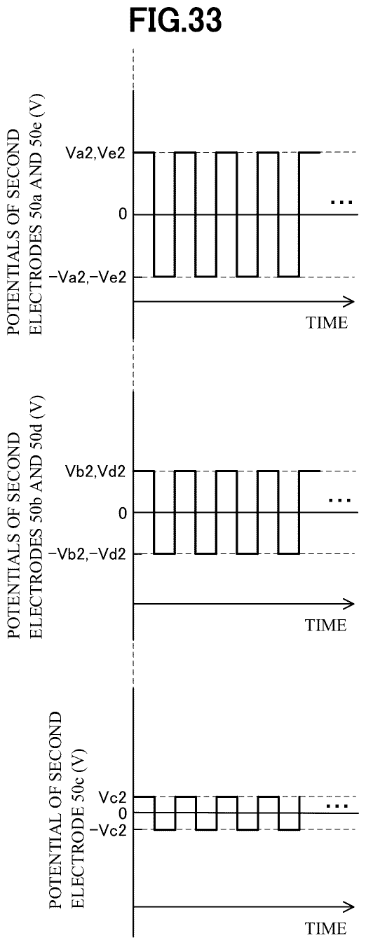

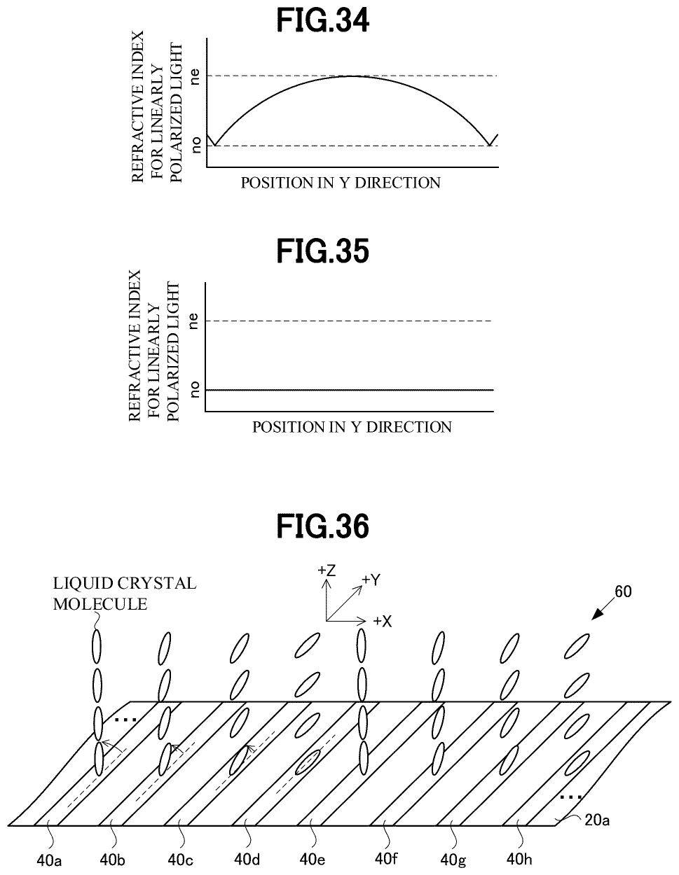

In the first state of the liquid-crystal light deflection panel 10 in the embodiment, the controller 90 applies a predetermined electric field to the liquid crystals 60, and thus aligns the liquid crystals 60 in a predetermined state, as in Embodiment 1. Specifically, the controller 90 adjusts the electric potentials of the first electrodes 40 to the ground potential, and adjusts the electric potentials of the second electrodes 50a and 50e illustrated in FIG. 32 to the electric potentials ±Va2 and ±Ve2 for generating a distribution of refractive indexes in the liquid crystals 60 in accordance with the levels of deflection (FIG. 33). The controller 90 adjusts the electric potentials of the second electrodes 50b and 50d to the electric potentials ±Vb2 and ±Vd2 for generating a distribution of refractive indexes in the liquid crystals 60 in accordance with the levels of deflection, and adjusts the electric potential of the second electrode 50c to the electric potential ±Vc2 for generating a distribution of refractive indexes in the liquid crystals 60 in accordance with the levels of deflection (FIG. 33). The values of the electric potentials ±Va2 to ±Ve2 are defined to satisfy the expression: |±Va2|=|±Ve2|>|±Vb2|=|±Vd2|>|±Vc2|. These adjusted electric potentials lead to application of the predetermined electric field to the liquid crystals 60, and thus drive the liquid crystals 60 toward the +Z direction. As illustrated in FIG. 32, the angle of elevation of the liquid crystal molecules relative to the first main surface 20a of the first substrate 20 toward the +Z direction increases from the second electrode 50c to the second electrode 50a, and the angle of elevation of the liquid crystal molecules relative to the first main surface 20a of the first substrate 20 toward the +Z direction increases from the second electrode 50c to the second electrode 50e. In this case, the distribution of refractive indexes of the liquid-crystal light deflection panel 10 for the linearly polarized light L1 with the polarization direction in the Y direction has variations repeated in a predetermined cycle in the Y direction, as illustrated in FIG. 34. The liquid-crystal light deflection panel 10 thus serves as a lenticular lens array extending in the X direction and arranged in the Y direction.

The second state of the liquid-crystal light deflection panel 10 in the embodiment is identical to the second state of the liquid-crystal light deflection panel 10 in Embodiment 1 (FIG. 11). The controller 90 applies, to the liquid crystals 60, a uniform electric field for driving the liquid crystals 60 toward the direction identical to the direction in which the liquid crystals 60 are driven to induce a transition from the initial state to the first state, as in Embodiment 1. The uniform electric field drives at least some of the liquid crystals 60 toward the direction (orthogonal to the initial alignment direction) identical to the driving direction for a transition from the initial state to the first state. Specifically, the controller 90 adjusts the electric potentials of the first electrodes 40 to the ground potential, and adjusts the electric potentials of the second electrodes 50a to 50e to the same potential (for example, electric potential for aligning the liquid crystals 60 in the Z direction). These adjusted electric potentials drive at least some of the liquid crystals 60 toward the +Z direction, align the liquid crystal molecules in the Z direction, for example, and bring the liquid crystals 60 into the uniform alignment state. This state provides an even distribution of refractive indexes of the liquid-crystal light deflection panel 10 for the linearly polarized light L1 (specifically, the refractive indexes for the linearly polarized light L1 are all equal to the ordinary refractive index no of the liquid crystals 60) as illustrated in FIG. 35. The liquid-crystal light deflection panel 10 thus does not serve as a lenticular lens array.

The liquid crystal light deflector 100 according to the embodiment can also reduce the response time required for a transition from the state causing deflection to the state causing no deflection, as in Embodiments 1 to 3. The liquid crystal light deflector 100 can avoid the non-uniform optical properties of the liquid-crystal light deflection panel 10. The liquid crystal light deflector 100 can achieve a simpler electrode configuration of the liquid-crystal light deflection panel 10 and a simpler configuration of the controller 90.

### Embodiment 5

In Embodiments 1 to 4, the liquid-crystal light deflection panel 10 serves as a lenticular lens array. The liquid-crystal light deflection panel 10 may also serve as a diffraction grating.

The liquid-crystal light deflection panel 10 in this embodiment serves as a diffraction grating. The liquid crystal light deflector 100 according to the embodiment has the same configurations as the liquid crystal light deflector 100 according to Embodiment 1, except for the alignment of the liquid crystals 60 (electric potentials of the first electrodes 40) and the distribution of refractive indexes of the liquid-crystal light deflection panel 10 in the first state. The description focuses on the alignment of the liquid crystals 60 (electric potentials of the first electrodes 40) and the distribution of refractive indexes of the liquid-crystal light deflection panel 10 in the first state in the embodiment.

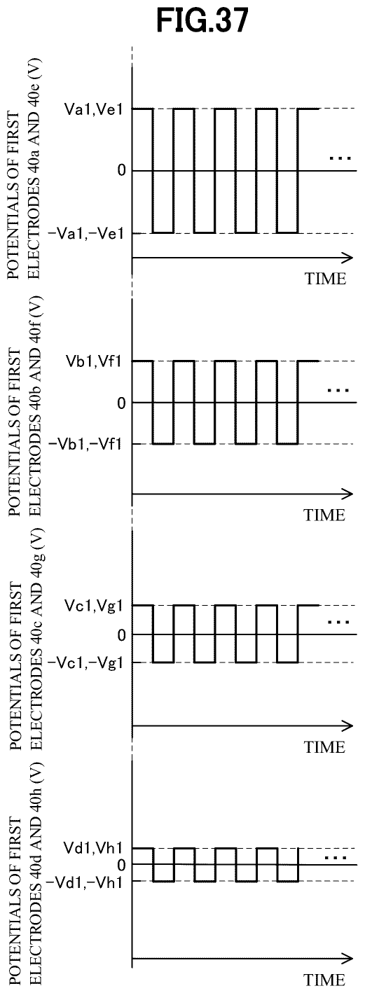

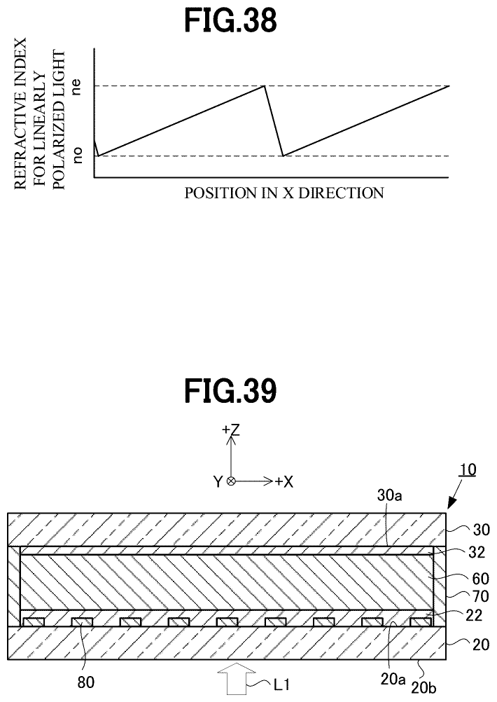

In the first state of the liquid-crystal light deflection panel 10 in the embodiment, the controller 90 applies a predetermined electric field to the liquid crystals 60, and thus aligns the liquid crystals 60 in a predetermined state, as in Embodiment 1. Specifically, the controller 90 adjusts the electric potential of the second electrode 50 to the ground potential, adjusts the electric potentials of the first electrodes 40a and 40e illustrated in FIG. 36 to the electric potentials ±Va1 and ±Ve1 for generating a distribution of refractive indexes in the liquid crystals 60 in accordance with the levels of deflection, and adjusts the electric potentials of the first electrodes 40b and 40f to the electric potentials ±Vb1 and ±Vf1 for generating a distribution of refractive indexes in the liquid crystals 60 in accordance with the levels of deflection (FIG. 37). The controller 90 adjusts the electric potentials of the first electrodes 40c and 40g to the electric potentials ±Vc1 and ±Vg1 for generating a distribution of refractive indexes in the liquid crystals 60 in accordance with the levels of deflection, and adjusts the electric potentials of the first electrodes 40d and 40h to the electric potentials ±Vd1 and ±Vh1 for generating a distribution of refractive indexes in the liquid crystals 60 in accordance with the levels of deflection (FIG. 37). The values of the electric potentials ±Va1 to ±Vh1 are defined to satisfy the expression: |±Va1|=|±Ve1|>|±Vb1|=|±Vf1|>|±Vc1|=|±Vg1|>|±Vd1|=|±Vh1|. These adjusted electric potentials lead to application of the predetermined electric field to the liquid crystals 60, and thus drive the liquid crystals 60 toward the +Z direction. As illustrated in FIG. 36, the angle of elevation of the liquid crystal molecules relative to the first main surface 20a of the first substrate 20 toward the +Z direction increases from the first electrode 40d to the first electrode 40a, and the angle of elevation of the liquid crystal molecules relative to the first main surface 20a of the first substrate 20 toward the +Z direction increases from the first electrode 40h to the first electrode 40e. In this case, the distribution of refractive indexes of the liquid-crystal light deflection panel 10 for the linearly polarized light L1 with the polarization direction in the Y direction has linear variations repeated in a predetermined cycle in the X direction, as illustrated in FIG. 38. The liquid-crystal light deflection panel 10 thus serves as a diffraction grating.

In this embodiment, the controller 90 applies the uniform electric field to the liquid crystals 60, drives at least some of the liquid crystals 60 toward the direction (identical to the driving direction for a transition from the initial state to the first state) orthogonal to the initial alignment direction, and thus causes the liquid-crystal light deflection panel 10 to transition from the first state causing deflection to the second state causing no deflection, as in Embodiments 1 to 4. The liquid crystal light deflector 100 can thus reduce the response time required for a transition from the state causing deflection to the state causing no deflection. The liquid crystal light deflector 100 can avoid the non-uniform optical properties of the liquid-crystal light deflection panel 10. The liquid crystal light deflector 100 can achieve a simpler electrode configuration of the liquid-crystal light deflection panel 10 and a simpler configuration of the controller 90.

### Embodiment 6

In Embodiments 1 to 5, the first substrate 20 is provided with the first electrodes 40, and the second substrate 30 is provided with the one or more second electrodes 50. The electrodes for application of an electric field to the liquid crystals 60 may also be mounted on either one of the first substrate 20 and the second substrate 30.

The liquid-crystal light deflection panel 10 in this embodiment serves as a diffraction grating. The liquid crystal light deflector 100 according to the embodiment has the same configurations as the liquid crystal light deflector 100 according to Embodiment 1, except for multiple electrodes 80 for applying an electric field to the liquid crystals 60, the alignment of the liquid crystals 60 (electric potentials of the electrodes 80), and the distribution of refractive indexes.

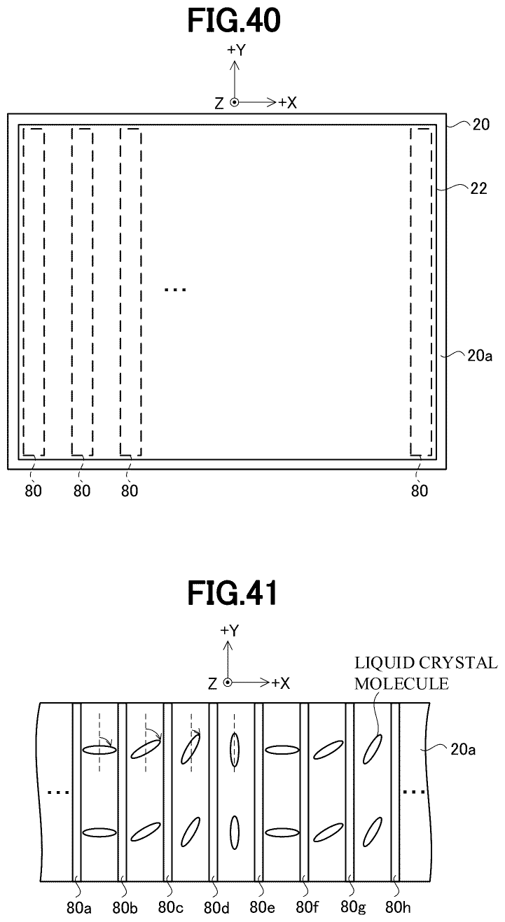

The electrodes 80 for applying an electric field to the liquid crystals 60 are mounted on the first main surface 20a of the first substrate 20, as illustrated in FIGS. 39 and 40. The electrodes 80 are each a linear electrode having a rectangular shape and extending in the Y direction. The electrodes 80 are arranged at a predetermined interval in the X direction. The electrodes 80 are individually connected to the controller 90 via wires, which are not illustrated. The alignment film 22 covers the first main surface 20a of the first substrate 20 and the electrodes 80. The liquid-crystal light deflection panel 10 in this embodiment includes no electrode on the second substrate 30.

The initial state of the liquid-crystal light deflection panel 10 in the embodiment is identical to the initial state of the liquid-crystal light deflection panel 10 in Embodiment 1. The controller 90 adjusts the electric potentials of the electrodes 80 to the same potential, and thus applies no electric field to the liquid crystals 60, thereby maintaining the liquid crystals 60 in the initial alignment state (alignment in the Y direction). This state provides an even distribution of refractive indexes of the liquid-crystal light deflection panel 10 for the linearly polarized light L1 with the polarization direction in the Y direction (specifically, the refractive indexes for the linearly polarized light L1 are all equal to the extraordinary refractive index ne of the liquid crystals 60). The liquid-crystal light deflection panel 10 thus does not serve as a diffraction grating.

In the first state of the liquid-crystal light deflection panel 10 in the embodiment, the controller 90 applies a predetermined electric field to the liquid crystals 60, and thus aligns the liquid crystals 60 in a predetermined state, as in Embodiment 1. Specifically, the controller 90 adjusts the electric potentials of the electrodes 80a to 80h illustrated in FIG. 41, such that the electric potential of the electrode 80d is equal to the electric potential of the electrode 80e, the absolute difference in electric potential between the electrodes 80a and 80b is larger than the absolute difference in electric potential between the electrodes 80b and 80c, which is larger than the absolute difference in electric potential between the electrodes 80c and 80d, and the absolute difference in electric potential between the electrodes 80e and 80f is larger than the absolute difference in electric potential between the electrodes 80f and 80g, which is larger than the absolute difference in electric potential between the electrodes 80g and 80h. These adjusted electric potentials lead to application of the predetermined electric field to the liquid crystals 60, and thus drive the liquid crystals 60 toward the +X direction. As illustrated in FIG. 41, the angle of the major axes of the liquid crystal molecules from the +Y direction increases from the electrode 80d to the electrode 80a, and the angle of the major axes of the liquid crystal molecules from the +Y direction increases from the electrode 80h to the electrode 80e. In this case, the distribution of refractive indexes of the liquid-crystal light deflection panel 10 for the linearly polarized light L1 with the polarization direction in the Y direction has linear variations repeated in a predetermined cycle in the X direction, like the distribution of refractive indexes in the first state in Embodiment 5 (FIG. 38). The liquid-crystal light deflection panel 10 thus serves as a diffraction grating.

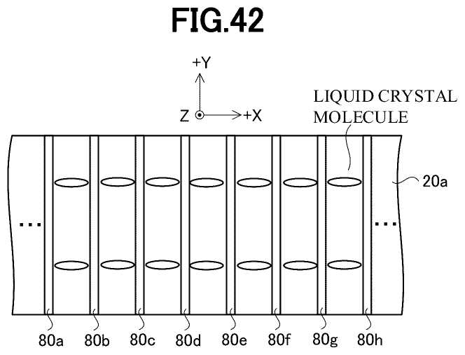

In the second state of the liquid-crystal light deflection panel 10 in the embodiment, the controller 90 applies a uniform electric field to the liquid crystals 60, and thus drives at least some of the liquid crystals 60 toward the direction (orthogonal to the initial alignment direction) identical to the driving direction for a transition from the initial state to the first state, and uniformly aligns the liquid crystals 60, as in Embodiment 1. Specifically, the controller 90 adjusts the electric potentials of the electrodes 80a, 80c, 80e, and 80g among the electrodes 80a to 80h to the same potential, adjusts the electric potentials of the electrodes 80b, 80d, 80f, and 80h to the same potential, and provides a difference between the electric potential of the electrodes 80a, 80c, 80e, and 80g and the electric potential of the electrodes 80b, 80d, 80f, and 80h. These adjusted electric potentials drive at least some of the liquid crystals 60 toward the X direction as illustrated in FIG. 42, align the liquid crystal molecules in the X direction, for example, and bring the liquid crystals 60 into the uniform alignment state. This state provides an even distribution of refractive indexes of the liquid-crystal light deflection panel 10 for the linearly polarized light L1 (specifically, the refractive indexes for the linearly polarized light L1 are all equal to the ordinary refractive index no of the liquid crystals 60). The liquid-crystal light deflection panel 10 thus does not serve as a diffraction grating.

The liquid crystal light deflector 100 according to the embodiment can also reduce the response time required for a transition from the state causing deflection to the state causing no deflection, as in Embodiments 1 to 4. The liquid crystal light deflector 100 can avoid the non-uniform optical properties of the liquid-crystal light deflection panel 10. The liquid crystal light deflector 100 can achieve a simpler electrode configuration of the liquid-crystal light deflection panel 10 and a simpler configuration of the controller 90.

### Embodiment 7

As described above in Embodiment 1, the controller 90 may control the electric potentials of the first electrodes 40 and the electric potential of the second electrode 50, stop application of the uniform electric field to the liquid crystals 60, and thus cause the liquid-crystal light deflection panel 10 to transition from the second state causing no deflection to the initial state causing no deflection.

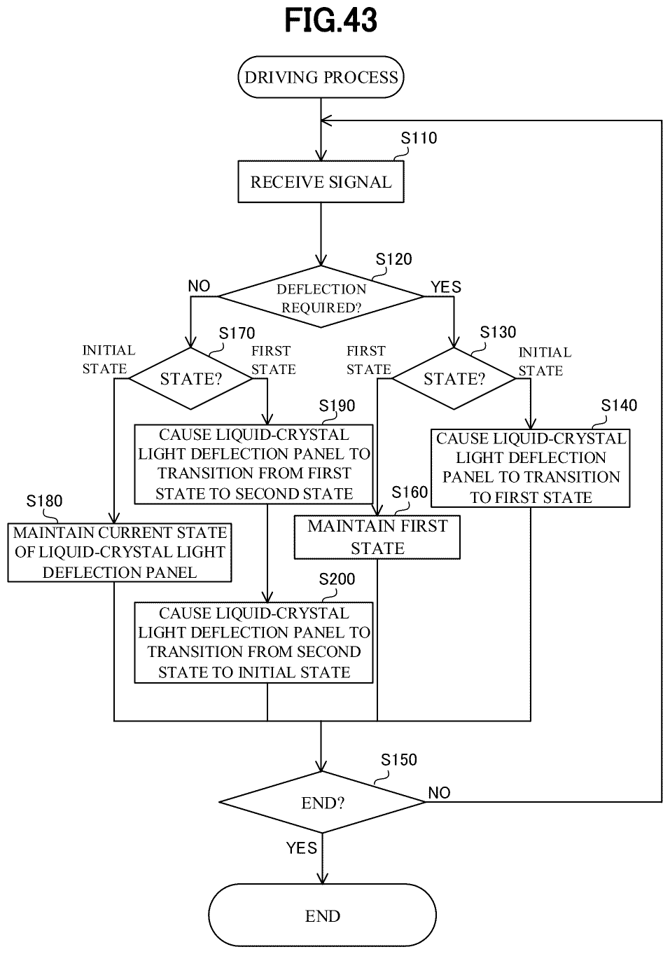

For example, the driving process of the liquid crystal light deflector 100 may be modified as illustrated in FIG. 43. Specifically, the controller 90, after Step S190 of causing the liquid-crystal light deflection panel 10 to transition from the first state to the second state, may stop application of the uniform electric field to the liquid crystals 60, and thus cause the liquid-crystal light deflection panel 10 to transition from the second state to the initial state causing no deflection of the linearly polarized light L1 (state not serving as a lenticular lens) (Step S200). The refractive indexes of the liquid-crystal light deflection panel 10 for the linearly polarized light L1, which include the liquid crystals 60 uniformly aligned in the second state, uniformly shift in response to a transition of the liquid-crystal light deflection panel 10 from the second state to the initial state. The liquid-crystal light deflection panel 10 during or after the transition does not cause deflection either. The driving process in the embodiment causes the liquid-crystal light deflection panel 10 to transition from the second state involving application of a voltage to the liquid crystals 60 to the initial state involving application of no voltage to the liquid crystals 60, and thus achieves a lower power consumption.

The driving process in the embodiment involves Step S200 and then the step (Step S150) of receiving a signal indicating termination of the driving process. When the liquid-crystal light deflection panel 10 is in the initial state in Step S130 (Step S130: initial state), the controller 90 applies, to the liquid crystals 60 of the liquid-crystal light deflection panel 10, the predetermined electric field for driving the liquid crystals 60 toward the direction orthogonal to the initial alignment direction, and thus causes the liquid-crystal light deflection panel 10 to transition from the initial state to the first state (Step S140). When the liquid-crystal light deflection panel 10 before reception of the signal is in the initial state in Step S170 (Step S170: initial state), the controller 90 maintains the current state of the liquid-crystal light deflection panel 10 (Step S180).

### Embodiment 8

In Embodiment 1, in the case where the liquid-crystal light deflection panel 10 serves as a lenticular lens array, the controller 90 applies, to the liquid crystals 60, the predetermined electric field for driving the liquid crystals 60 toward the direction orthogonal to the initial alignment direction, and thus drives the liquid crystals 60 toward the direction orthogonal to the initial alignment direction, aligns the liquid crystals 60 in the predetermined state, and thus achieves the first state causing deflection.

In order to cause the liquid-crystal light deflection panel 10 to transition from the initial state causing no deflection to the first state causing deflection, the controller 90 may apply a first electric field higher than the predetermined electric field to the liquid crystals 60, and then apply the predetermined electric field to the liquid crystals 60. The first electric field drives the liquid crystals 60 toward the direction orthogonal to the initial alignment direction of the liquid crystals 60. The first electric field has a distribution of intensities corresponding to the distribution of refractive indexes in the liquid crystals 60 that cause deflection. The first electric field has an intensity higher than the predetermined electric field. That is, in order to cause the liquid-crystal light deflection panel 10 to transition from the initial state causing no deflection to the first state causing deflection, the controller 90 may overdrive the liquid-crystal light deflection panel 10.

In order to cause the liquid-crystal light deflection panel 10 to transition from another state causing no deflection, which is in the middle of a transition from the second state causing no deflection to the initial state causing no deflection, to the first state, the controller 90 may apply the predetermined electric field to the liquid crystals 60, without applying the first electric field to the liquid crystals 60.

The liquid crystal light deflector 100 according to the embodiment has the same configurations as the liquid crystal light deflector 100 according to Embodiment 1, except for the application of electric fields to the liquid crystals 60 by the controller 90. The description focuses on the application of electric fields to the liquid crystals 60 by the controller 90.

The controller 90 in the embodiment controls the electric field (voltage) to be applied to the liquid crystals 60 via the first electrodes 40 and the second electrode 50, and thus induces a transition of the state of the liquid-crystal light deflection panel 10, like the controller 90 in Embodiment 1.

In this embodiment, in order to cause the liquid-crystal light deflection panel 10 to transition from the initial state including the liquid crystals 60 in the initial alignment state and not deflecting the linearly polarized light L1, to the first state including the liquid crystals 60 aligned in the predetermined state and deflecting the linearly polarized light L1, the controller 90 first applies the first electric field to the liquid crystals 60 in the initial alignment state and then applies the predetermined electric field to the liquid crystals 60. The predetermined electric field drives the liquid crystals 60 toward the direction orthogonal to the initial alignment direction of the liquid crystals 60, and generates a distribution of refractive indexes in the liquid crystals 60 in accordance with the levels of deflection. The first electric field drives the liquid crystals 60 toward the direction orthogonal to the initial alignment direction of the liquid crystals 60, corresponds to the distribution of refractive indexes in the liquid crystals 60 that cause deflection (that is, the distribution of refractive indexes in accordance with the levels of deflection), and is an electric field (that is, overdrive voltage) higher than the predetermined electric field. The period of application of the first electric field to the liquid crystals 60 is hereinafter referred to as “period P1”, and the period of application of the predetermined electric field to the liquid crystals 60 is hereinafter referred to as “period P2”.

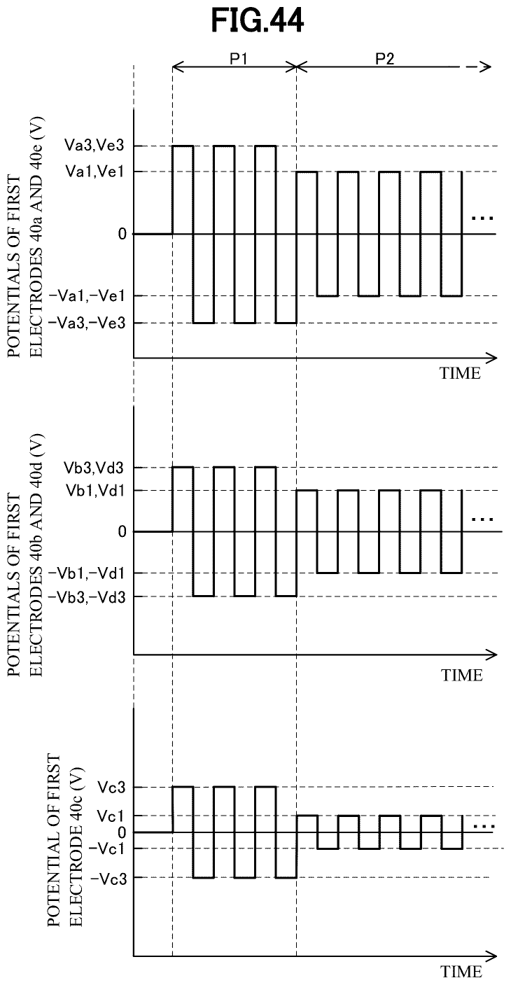

The first electric field and the predetermined electric field are specifically described below, focusing on exemplary first electrodes 40a to 40e illustrated in FIG. 8 and an exemplary second electrode 50. In the period P1, the controller 90 in the embodiment adjusts the electric potential of the second electrode 50 to the ground potential, adjusts the electric potentials of the first electrodes 40a and 40e to the electric potentials ±Va3 and ±Ve3 in accordance with the distribution of refractive indexes in the liquid crystals 60 that cause deflection, as illustrated in FIG. 44. The absolute value of the electric potentials ±Va3 and ±Ve3 is larger than the absolute value of the electric potentials ±Va1 and ±Ve1 for generating a distribution of refractive indexes in the liquid crystals 60 in accordance with the levels of deflection. The controller 90 in the embodiment adjusts the electric potentials of the first electrodes 40b and 40d to the electric potentials ±Vb3 and ±Vd3 in accordance with the distribution of refractive indexes in the liquid crystals 60 that cause deflection. The absolute value of the electric potentials ±Vb3 and ±Vd3 is larger than the absolute value of the electric potentials ±Vb1 and ±Vd1 for generating a distribution of refractive indexes in the liquid crystals 60 in accordance with the levels of deflection. The controller 90 in the embodiment adjusts the electric potential of the first electrode 40c to the electric potential ±Vc3, in accordance with the distribution of refractive indexes in the liquid crystals 60 that cause deflection. The absolute value of the electric potential ±Vc3 is larger than the absolute value of the electric potential ±Vc1 for generating a distribution of refractive indexes in the liquid crystals 60 in accordance with the levels of deflection. The values of the electric potentials ±Va3 to ±Ve3 are defined such that the absolute value of the electric potentials ±Va3 and ±Ve3 is larger than the absolute value of the electric potentials ±Vb3 and ±Vd3, which is larger than the absolute value of the electric potential ±V3c. The controller 90 in the embodiment thus applies the first electric field to the liquid crystals 60.

In the subsequent period P2, the controller 90 in the embodiment adjusts the electric potential of the second electrode 50 to the ground potential, and adjusts the electric potentials of the first electrodes 40a and 40e to the electric potentials ±V1a and ±Ve1 for generating a distribution of refractive indexes in the liquid crystals 60 in accordance with the levels of deflection. The controller 90 adjusts the electric potentials of the first electrodes 40b and 40d to the electric potentials ±Vb1 and ±Vd1 for generating a distribution of refractive indexes in the liquid crystals 60 in accordance with the levels of deflection, and adjusts the electric potential of the first electrode 40c to the electric potential ±Vc1 for generating a distribution of refractive indexes in the liquid crystals 60 in accordance with the levels of deflection. The values of the electric potentials ±Va1 to ±Ve1 are defined to satisfy the expression: |±Va1|=|±Ve1|>|±Vb1|=|±Vd1|>|±Vc1|. The controller 90 in the embodiment thus applies, to the liquid crystals 60, the predetermined electric field for generating a distribution of refractive indexes in the liquid crystals 60 in accordance with the levels of deflection.

The following describes the distribution of refractive indexes for the linearly polarized light L1, and a response time τon required for a transition from the initial state causing no deflection of the linearly polarized light L1 to the first state causing deflection of the linearly polarized light L1, on the basis of results of simulations. The liquid-crystal light deflection panel 10 (first electrodes 40 and liquid crystals 60) in these simulations has the same configurations as the liquid-crystal light deflection panel 10 in the simulations in Embodiment 1.

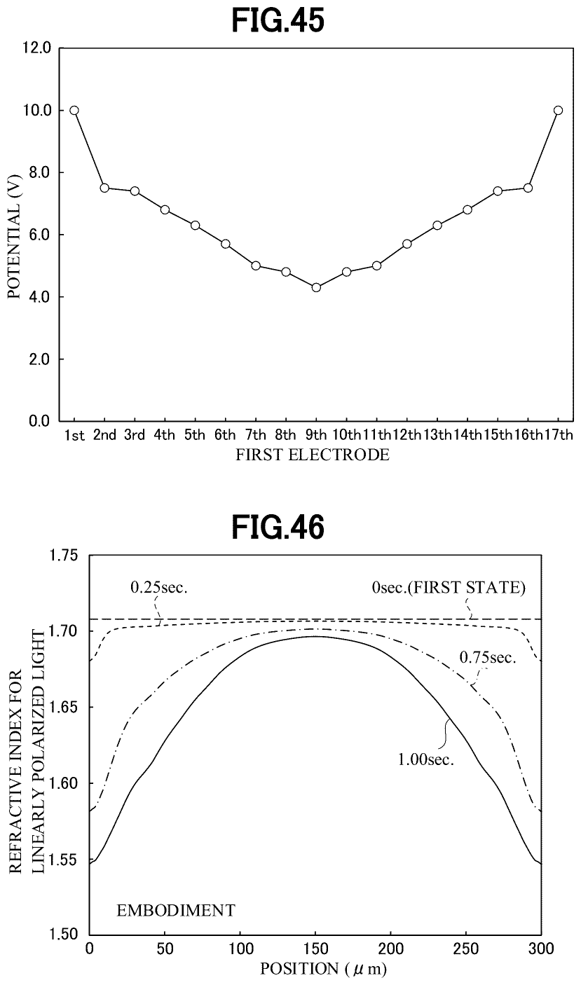

These simulations assumed the period P1 to be one second (P1=1 sec.). The controller 90 adjusted the electric potential of the second electrode 50 to the ground potential, and adjusted the electric potentials of the 1st to 17th first electrodes 40 to the electric potentials illustrated in FIG. 45, and thus applied the first electric field (overdrive voltages of 4.3 to 10.0 V) to the liquid crystals 60 (in the initial alignment state) of the liquid-crystal light deflection panel 10 in the initial state. In the subsequent period P2, the controller 90 adjusted the electric potentials of the 1st to 17th first electrodes 40 to the predetermined potentials illustrated in FIG. 14, and thus achieved the first state as in Embodiment 1.

The transition from the initial state causing no deflection to the first state causing deflection accompanied a variation in distribution of refractive indexes for the linearly polarized light L1, as illustrated in FIG. 46. Assuming that the difference between the maximum and minimum values in the distribution of refractive indexes in the liquid crystals 60 in the first state causing deflection was 100%, the difference at the same position was calculated between the value in the distribution of refractive indexes in the first state and the value in the distribution of refractive indexes at each time point. The time until when the calculated difference reached a maximum value of 10% (0.015 in these simulations) was regarded as the response time τon required for a transition from the initial state causing no deflection to the first state causing deflection. The response time τon of the liquid-crystal light deflection panel 10 in the embodiment was found to be one second.

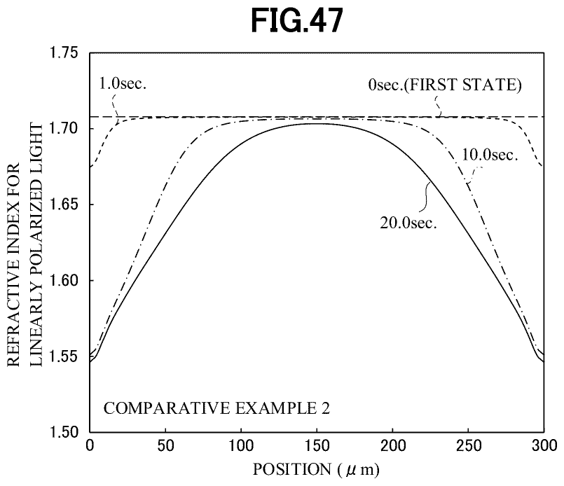

In contrast, in a comparative example (hereinafter referred to as “Comparative Example 2”), the controller 90 applied the predetermined electric field to the liquid crystals 60 in the initial alignment state and thus caused the liquid-crystal light deflection panel 10 to transition from the initial state causing no deflection to the first state causing deflection. The transition accompanied a variation in distribution of refractive indexes for the linearly polarized light L1, as illustrated in FIG. 47. Comparative Example 2 provided a response time τon of 20 seconds. As described above, the controller 90 applies the first electric field to the liquid crystals 60 in the initial alignment state and then applies the predetermined electric field to the liquid crystals 60, and thus causes the liquid-crystal light deflection panel 10 to transition from the initial state causing no deflection to the first state causing deflection. This configuration can reduce the response time τon required for a transition from the initial state to the first state.

In this embodiment, in the case of transition of the liquid-crystal light deflection panel 10 from the first state including the liquid crystals 60 aligned in the predetermined state and deflecting the linearly polarized light L1 to the state causing no deflection of the linearly polarized light L1, the controller 90 causes the liquid-crystal light deflection panel 10 to transition from the first state to the second state and then transition from the second state to the initial state, as in Embodiment 7. In the second state, the liquid-crystal light deflection panel 10 includes the liquid crystals 60 uniformly aligned by receiving the uniform electric field for driving at least some of the liquid crystals 60 toward the direction orthogonal to the initial alignment direction, has an even distribution of refractive indexes, and does not reflect light. The transition from the first state to the second state and the transition from the second state to the initial state in the embodiment are identical to those in Embodiments 1 and 7.

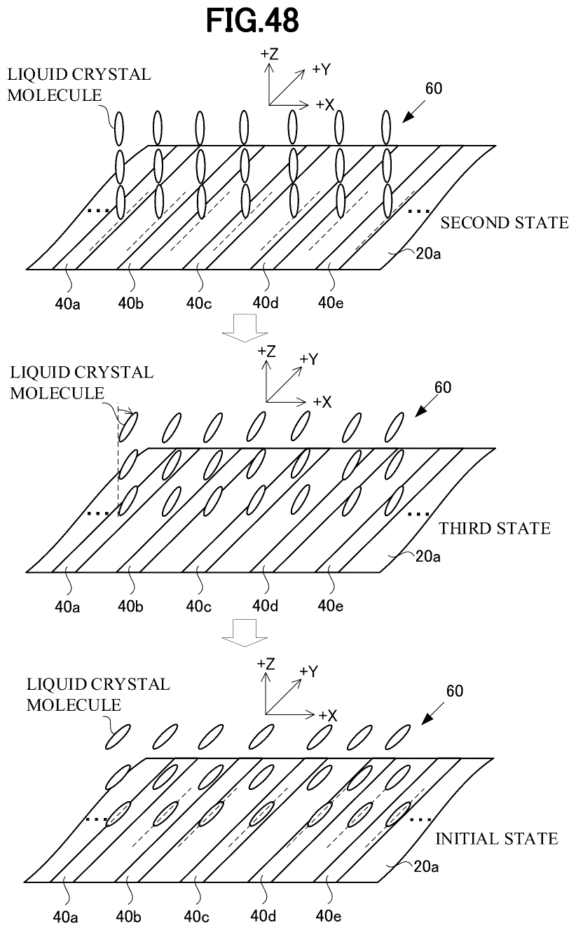

The controller 90 stops application of the uniform electric field to the liquid crystals 60, and thus causes the liquid-crystal light deflection panel 10 to transition from the second state to the initial state. The state causing no deflection in the middle of a transition from the second state causing no deflection to the initial state causing no deflection is hereinafter referred to as “third state”. FIG. 48 illustrates an exemplary alignment of the liquid crystals 60 in the third state.

In order to cause the liquid-crystal light deflection panel 10 to transition from the third state causing no deflection to the first state causing deflection, the controller 90 in the embodiment applies the predetermined electric field to the liquid crystals 60, without applying the first electric field to the liquid crystals 60. That is, the controller 90 in the embodiment does not overdrive the liquid-crystal light deflection panel 10 in order to cause the liquid-crystal light deflection panel 10 to transition from the third state causing no deflection to the first state causing deflection.

The third state of the liquid-crystal light deflection panel 10 is in the middle of a transition from the second state causing no deflection to the first state causing deflection. The refractive indexes for the linearly polarized light L1 in the liquid crystals 60 thus uniformly shift from the ordinary refractive index no to the extraordinary refractive index ne in response to a change in the alignment of the liquid crystals 60 during a transition to a third state, as described above in Embodiment 1. The liquid-crystal light deflection panel 10 during or after the transition does not cause deflection either. In the third state, the alignment of the liquid crystals 60 changes in accordance with the time (hereinafter referred to as “elapsed time SP”) elapsed since the stop of application of the uniform electric field to the liquid crystals 60. If the liquid crystals 60 receive the constant first electric field regardless of the elapsed time SP, the liquid crystals 60 may be excessively driven and result in a longer response time τon. In order to avoid this problem, the controller 90 in the embodiment applies the predetermined electric field to the liquid crystals 60 without applying the first electric field to the liquid crystals 60, in order to cause the liquid-crystal light deflection panel 10 to transition from the third state to the first state.

The following describes the distribution of refractive indexes for the linearly polarized light L1, and the response time τon required for a transition from the third state causing no deflection of the linearly polarized light L1 to the first state causing deflection of the linearly polarized light L1, on the basis of results of simulations. The liquid-crystal light deflection panel 10 (first electrodes 40 and liquid crystals 60) in these simulations has the same configurations as the liquid-crystal light deflection panel 10 in the simulations in Embodiment 1.

In these simulations, the controller 90 adjusted the electric potential of the second electrode 50 to the ground potential, and adjusted the electric potentials of the 1st to 17th first electrodes 40 to the electric potentials illustrated in FIG. 14 in the order from the negative side of the X direction, and thus achieved the first state causing deflection. The controller 90 then adjusted the electric potentials of the 1st to 17th first electrodes 40 to 10 V (for two seconds), and thus achieved the second state, as in the simulations in Embodiment 1. The controller 90 then adjusted the electric potentials of the 1st to 17th first electrodes 40 to the ground potential, and thus stopped application of the uniform electric field to the liquid crystals 60. After elapse of 10 seconds since the stop of application of the uniform electric field to the liquid crystals 60, the controller 90 adjusted the electric potentials of the 1st to 17th first electrodes 40 to the electric potentials illustrated in FIG. 14, and thus achieved the first state causing deflection. That is, the controller 90 applied the predetermined electric field to the liquid crystals 60 of the liquid-crystal light deflection panel 10 in the third state at the elapsed time SP of 10 seconds, and thus caused the liquid-crystal light deflection panel 10 to transition from the third state to the first state, without the overdrive control.

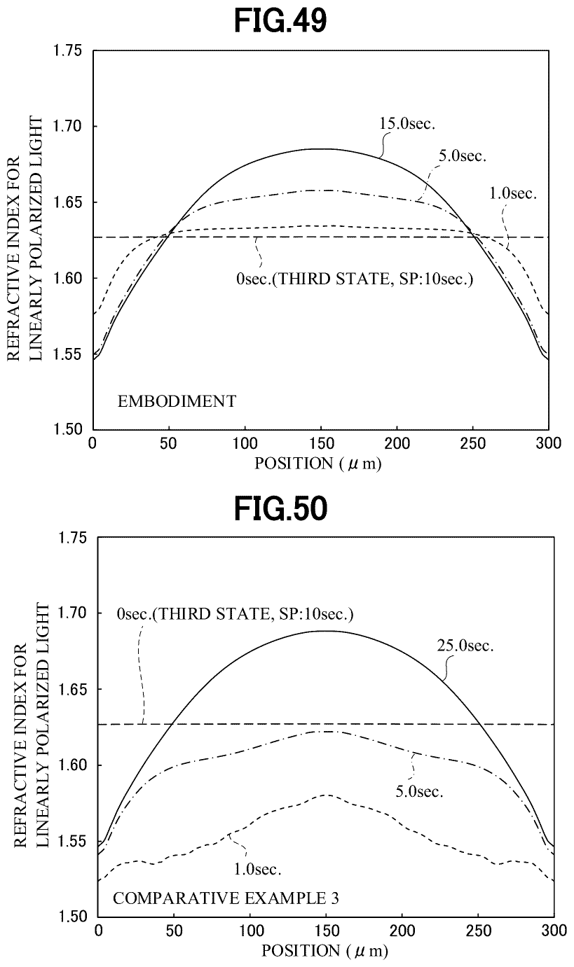

This transition accompanied a variation in distribution of refractive indexes for the linearly polarized light L1, as illustrated in FIG. 49. The response time τon from the third state to the first state was found to be 15 seconds.

In Comparative Example 3, after elapse of 10 seconds since the stop of application of the electric field to the liquid crystals 60, the controller 90 adjusted the electric potentials of the 1st to 17th first electrodes 40 to the electric potentials illustrated in FIG. 45, and thus applied the first electric field to the liquid crystals 60 for one second. The controller 90 then adjusted the electric potentials of the 1st to 17th first electrodes 40 to the predetermined potentials illustrated in FIG. 14, and thus achieved the first state. That is, the controller 90 performed overdrive control by applying the first electric field and the predetermined electric field to the liquid crystals 60 of the liquid-crystal light deflection panel 10 in the third state at the elapsed time SP of 10 seconds, and caused the liquid-crystal light deflection panel 10 to transition from the third state to the first state.

This transition accompanied a variation in distribution of refractive indexes for the linearly polarized light L1, as illustrated in FIG. 50. The response time τon from the third state to the first state was found to be 25 seconds. As described above, if the liquid-crystal light deflection panel 10 in the third state is overdriven, the liquid crystals 60 may be excessively driven and result in a longer response time τon.

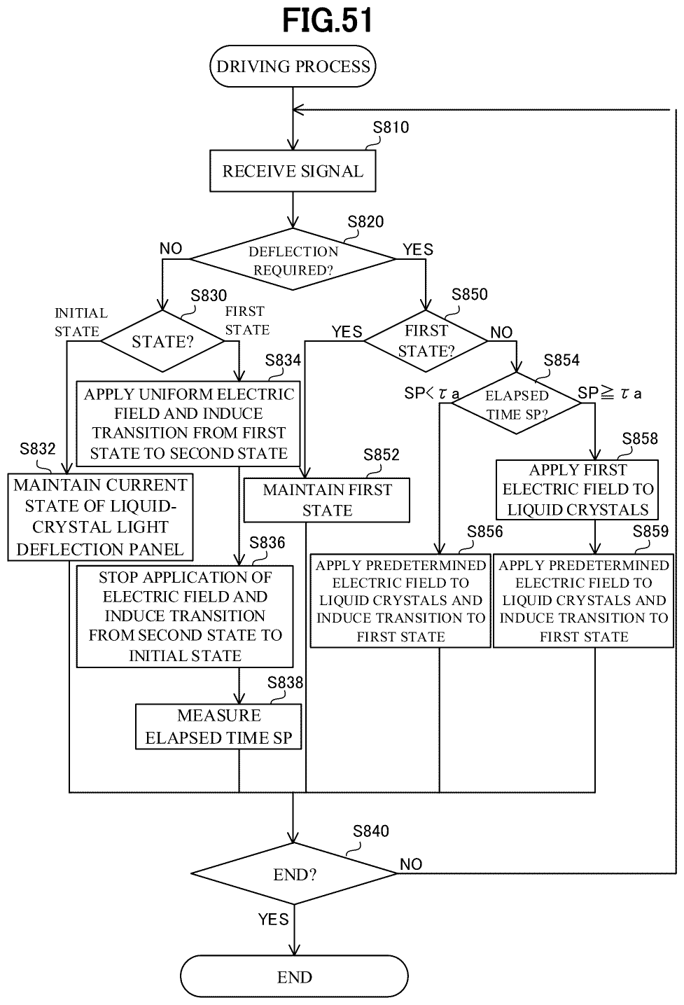

The following describes a driving process of the liquid crystal light deflector 100, with reference to FIG. 51. In response to electric power supply, the controller 90 of the liquid crystal light deflector 100 resets the liquid-crystal light deflection panel 10 to the initial state, as in Embodiment 1. The controller 90 then receives a signal indicating requirement of deflection from an external apparatus (Step S810).

The controller 90 then identifies the received signal (Step S820). When the received signal indicates that “deflection is not required” (Step S820; NO), the controller 90 identifies the state of the liquid-crystal light deflection panel 10 before reception of the signal (Step S830). When the liquid-crystal light deflection panel 10 before reception of the signal is in the initial state (Step S830: initial state), the controller 90 maintains the current state of the liquid-crystal light deflection panel 10 (Step S832). When receiving a signal indicating termination of the driving process from the external apparatus (Step S840; YES), the controller 90 terminates the driving process of the liquid crystal light deflector 100. In contrast, when receiving no signal indicating termination of the driving process from the external apparatus (Step S840; NO), the controller 90 returns the driving process of the liquid crystal light deflector 100 to the step (Step S810) of receiving a signal indicating requirement of deflection, and maintains the current state of the liquid-crystal light deflection panel 10 until reception of a subsequent signal.

When the liquid-crystal light deflection panel 10 before reception of the signal is in the first state (Step S830: first state), the controller 90 controls the electric potentials of the first electrodes 40 and the electric potential of the second electrode 50, and thus applies, to the liquid crystals 60, the uniform electric field for driving the liquid crystals 60 toward the direction (orthogonal to the initial alignment direction) identical to the direction in which the liquid crystals 60 are driven to induce a transition from the initial state to the first state. The controller 90 thus causes the liquid-crystal light deflection panel 10 to transition from the first state to the second state causing no deflection of the linearly polarized light L1 (Step S834). The controller 90 then stops application of the uniform electric field to the liquid crystals 60, and thus causes the liquid-crystal light deflection panel 10 to transition from the second state to the initial state causing no deflection (Step S836). The controller 90 then measures the time elapsed since the stop of application of the electric field to the liquid crystals 60, that is, measures the elapsed time SP (Step S838).

When receiving a signal indicating termination of the driving process from the external apparatus (Step S840; YES), the controller 90 terminates the driving process of the liquid crystal light deflector 100. In contrast, when receiving no signal indicating termination of the driving process from the external apparatus (Step S840; NO), the controller 90 returns the driving process of the liquid crystal light deflector 100 to the step (Step S810) of receiving a signal indicating requirement of deflection, and maintains the current initial state of the liquid-crystal light deflection panel 10 until reception of a subsequent signal.

When the received signal indicates that “deflection is required” (Step S820; YES), the controller 90 identifies whether the liquid-crystal light deflection panel 10 before reception of the signal is in the first state (Step S850). When the liquid-crystal light deflection panel 10 before reception of the signal is in the first state (Step S850; YES), the controller 90 maintains the current first state of the liquid-crystal light deflection panel 10 (Step S852). When receiving a signal indicating termination of the driving process from the external apparatus (Step S840; YES), the controller 90 terminates the driving process of the liquid crystal light deflector 100. In contrast, when receiving no signal indicating termination of the driving process from the external apparatus (Step S840; NO), the controller 90 returns the driving process of the liquid crystal light deflector 100 to the step (Step S810) of receiving a signal indicating requirement of deflection, and maintains the current first state of the liquid-crystal light deflection panel 10 until reception of a subsequent signal.

When the liquid-crystal light deflection panel 10 before reception of the signal is not in the first state (Step S850; NO), the controller 90 determines whether the elapsed time SP is shorter than a time (hereinafter referred to as “completion time ta”) required for completion of a transition of the liquid-crystal light deflection panel 10 from the second state to the initial state, or at least the completion time ta (Step S854). The completion time ta is determined in advance on the basis of examinations or simulations, and stored in the ROM 93 of the controller 90. When the elapsed time SP is shorter than the completion time ta (Step S854: SP<ta), which implies the liquid-crystal light deflection panel 10 in the third state, the controller 90 applies the predetermined electric field to the liquid crystals 60, and thus causes the liquid-crystal light deflection panel 10 to transition from the third state causing no deflection of the linearly polarized light L1, to the first state causing deflection of the linearly polarized light L1 (Step S856). The predetermined electric field drives the liquid crystals 60 toward the direction orthogonal to the initial alignment direction of the liquid crystals 60, and generates a distribution of refractive indexes in the liquid crystals 60 in accordance with the levels of deflection.

When receiving a signal indicating termination of the driving process from the external apparatus (Step S840; YES), the controller 90 terminates the driving process of the liquid crystal light deflector 100. In contrast, when receiving no signal indicating termination of the driving process from the external apparatus (Step S840; NO), the controller 90 returns the driving process of the liquid crystal light deflector 100 to the step (Step S810) of receiving a signal indicating requirement of deflection, and maintains the current first state of the liquid-crystal light deflection panel 10 until reception of a subsequent signal.

When the elapsed time SP is the completion time ta or longer (Step S854: SP≥ta), which implies the liquid-crystal light deflection panel 10 in the initial state, the controller 90 applies the first electric field to the liquid crystals 60 for the predetermined period (period P1) (Step S858). The controller 90 then applies the predetermined electric field to the liquid crystals 60, and thus causes the liquid-crystal light deflection panel 10 to transition from the initial state causing no deflection of the linearly polarized light L1, to the first state causing deflection of the linearly polarized light L1 (Step S859). The first electric field drives the liquid crystals 60 toward the direction orthogonal to the initial alignment direction of the liquid crystals 60, corresponds to the distribution of refractive indexes in the liquid crystals 60 that cause deflection, and is higher than the predetermined electric field.

When receiving a signal indicating termination of the driving process from the external apparatus (Step S840; YES), the controller 90 terminates the driving process of the liquid crystal light deflector 100. In contrast, when receiving no signal indicating termination of the driving process from the external apparatus (Step S840; NO), the controller 90 returns the driving process of the liquid crystal light deflector 100 to the step (Step S810) of receiving a signal indicating requirement of deflection, and maintains the current first state of the liquid-crystal light deflection panel 10 until reception of a subsequent signal.

In the driving process of the liquid crystal light deflector 100 according to the embodiment, the controller 90 applies the first electric field to the liquid crystals 60 in Step S858 and then applies the predetermined electric field to the liquid crystals 60 in Step S859, and thus causes the liquid-crystal light deflection panel 10 to transition from the initial state causing no deflection to the first state causing deflection. This configuration can reduce the response time τon required for a transition from the initial state to the first state.

As described above, the embodiment can reduce the response time τon required for a transition of the liquid-crystal light deflection panel 10 from the initial state to the first state.

The liquid crystal light deflector 100 according to the embodiment can also reduce the response time required for a transition from the state causing deflection to the state causing no deflection, like the liquid crystal light deflector 100 according to Embodiment 1. The liquid crystal light deflector 100 according to the embodiment can avoid disrupted alignment of the liquid crystals 60, and thus prevent the non-uniform optical properties of the liquid-crystal light deflection panel 10, in a transition of the liquid-crystal light deflection panel 10 from the state causing deflection to the state causing no deflection. The liquid crystal light deflector 100 according to the embodiment can achieve a simpler electrode configuration of the liquid-crystal light deflection panel 10 and a simpler configuration of the controller 90.

### Embodiment 9

In Embodiment 8, the controller 90 does not overdrive the liquid-crystal light deflection panel 10 in order to cause the liquid-crystal light deflection panel 10 to transition from the third state causing no deflection to the first state causing deflection. Alternatively, the controller 90 may overdrive the liquid-crystal light deflection panel 10 in the third state, by applying the first electric field varying depending on the elapsed time SP to the liquid crystals 60.

The liquid crystal light deflector 100 according to the embodiment has the same configurations as the liquid crystal light deflector 100 according to Embodiment 8, except for the configuration of causing the liquid-crystal light deflection panel 10 to transition from the initial state or third state causing no deflection to the first state causing deflection. The description focuses on a transition caused by the controller 90 from the initial state or third state to the first state.

In order to cause the liquid-crystal light deflection panel 10 to transition from the initial state or third state causing no deflection to the first state causing deflection, the controller 90 in the embodiment applies a first electric field varying depending on the elapsed time SP to the liquid crystals 60 for the predetermined period (period P1), and then applies a predetermined electric field to the liquid crystals 60. Specifically, when the elapsed time SP is shorter than the completion time ta, the controller 90 sets a higher intensity of the first electric field as the elapsed time SP extends. When the elapsed time SP is the completion time ta or longer, the controller 90 sets a constant intensity of the first electric field regardless of the elapsed time SP. This configuration can achieve appropriate overdrive control of the liquid-crystal light deflection panel 10 in the initial state or third state. The elapsed time SP indicates a time elapsed since the stop of application of the uniform electric field to the liquid crystals 60. The completion time ta indicates a time required for completion of a transition of the liquid-crystal light deflection panel 10 from the second state to the initial state.

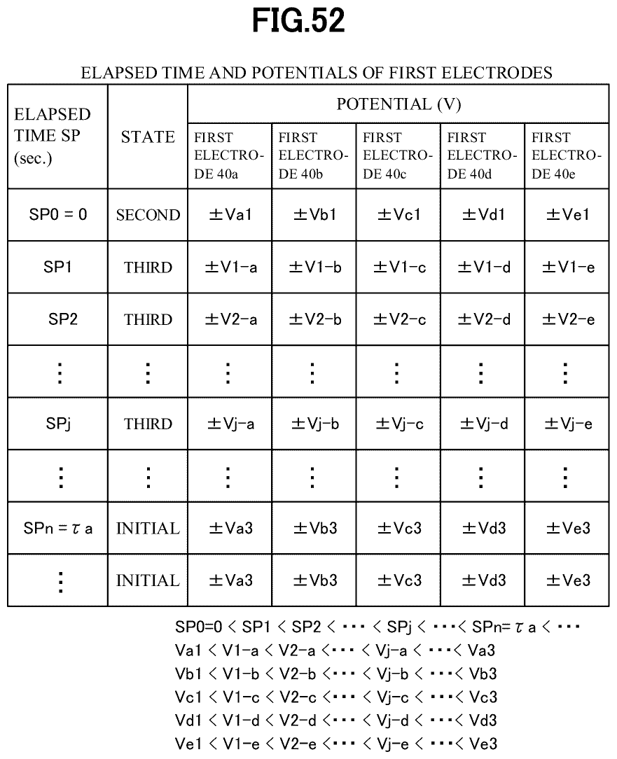

The following specifically describes the control of the electric potentials of the first electrodes 40 and the first electric field, focusing on exemplary first electrodes 40a to 40e illustrated in FIG. 8 and an exemplary second electrode 50. In the period P1, the controller 90 adjusts the electric potential of the second electrode 50 to the ground potential, and adjusts the electric potentials of the first electrodes 40a to 40e to the electric potentials varying depending on the elapsed time SP illustrated in FIG. 52.

FIG. 52 illustrates a relationship between the elapsed time SP and the electric potentials of the first electrodes 40a to 40e, and a magnitude relationship among the electric potentials of each of the first electrodes 40a to 40e at the individual elapsed times SP. In an exemplary case of application of the first electric field to the liquid crystals 60 at an elapsed time SP of SPj, the controller 90 adjusts the electric potential of the first electrode 40a to the electric potential ±Vj-a (j and n are natural numbers). The values of the electric potential of the first electrode 40a have a magnitude relationship represented by the expression: Va1<V1-a<V2-a< . . . <Vj-a< . . . <Va3, for example. The controller 90 sets larger absolute values of electric potentials of the individual first electrodes 40a to 40e, as the elapsed time SP extends from the time SP1 to the time SPn. The controller 90 can thus increase the intensity of the first electric field as the elapsed time SP extends. The relationship between the elapsed time SP illustrated in FIG. 52 and the electric potentials of the first electrodes 40 is stored into the ROM 93 of the controller 90 in the form of a lookup table.

The first electric field at the elapsed time SP0 is equal to the predetermined electric field for generating a distribution of refractive indexes in the liquid crystals 60 in accordance with the levels of deflection. The electric potentials Va1 to Ve1 of the first electrodes 40a to 40e illustrated in FIG. 52 are identical to the electric potentials Va1 to Ve1 of the first electrodes 40a to 40e in Embodiment 1. At the elapsed time SPn equal to the completion time ta (SPn=τa), the liquid-crystal light deflection panel 10 is in the initial state. The first electric field has a constant intensity at the elapsed time equal to or longer than the time SPn (that is, after completion of a transition of the liquid-crystal light deflection panel 10 to the initial state). At the elapsed time equal to or longer than the time SPn, the first electric field has the same intensity as the intensity of the first electric field in Embodiment 8. The values of the electric potentials of the first electrodes 40 at the same elapsed time SP have a magnitude relationship such that the absolute value of electric potential of the first electrode 40a is equal to the absolute value of electric potential of the first electrode 40e, which is larger than the absolute value of electric potential of the first electrode 40b, which is equal to the absolute value of electric potential of the first electrode 40d, which is larger than the absolute value of electric potential of the first electrode 40c.

The intensity of the first electric field (electric potentials of the first electrodes 40) is determined in advance on the basis of examinations or simulations, so as to achieve a shorter response time τon without excessive driving of the liquid crystals 60.

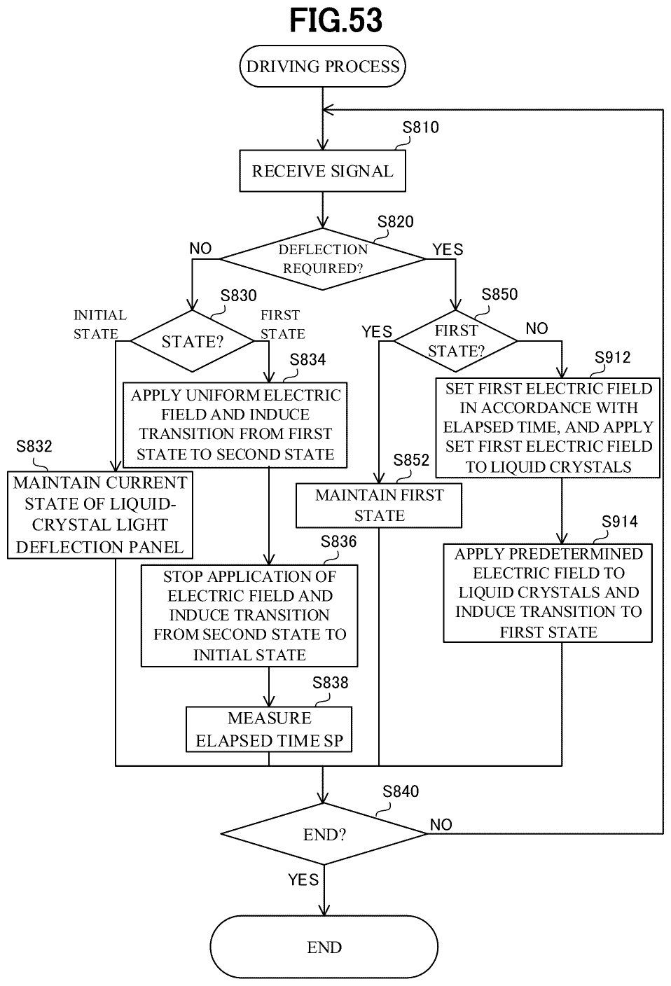

The following describes a driving process of the liquid crystal light deflector 100 according to the embodiment, with reference to FIG. 53. The description focuses on Steps S912 and S914, because Steps S810 to S852 in the driving process in the embodiment are identical to Steps S810 to S852 in Embodiment 8.

When the liquid-crystal light deflection panel 10 before reception of the signal is not in the first state (Step S850; NO), the controller 90 sets the first electric field depending on the elapsed time SP, and applies the set first electric field to the liquid crystals 60 for the predetermined period (Step S912). Specifically, the controller 90 sets the first electric field having an intensity varying depending on the elapsed time SP for the liquid crystals 60, on the basis of the relationship between the elapsed time SP and the electric potentials of the first electrodes 40 stored in the form of a lookup table (FIG. 52). The controller 90 applies the set first electric field to the liquid crystals 60 for the predetermined period. The controller 90 can thus set larger absolute values of electric potentials of the individual first electrodes 40a to 40e, as the elapsed time SP extends from the time SP1 to the time SPn. At the elapsed time SP equal to or longer than the time SPn, the controller 90 can set constant absolute values of electric potentials of the individual first electrodes 40a to 40e regardless of the elapsed time SP.

The controller 90 applies the set first electric field to the liquid crystals 60 for the predetermined period, and then applies the predetermined electric field to the liquid crystals 60, and thus causes the liquid-crystal light deflection panel 10 to transition to the first state (Step S914).

The embodiment can overdrive the liquid-crystal light deflection panel 10 in the initial state or third state, and can thus reduce the response time required for a transition of the liquid-crystal light deflection panel 10 from the initial state or third state to the first state.

The liquid crystal light deflector 100 according to the embodiment can also reduce the response time required for a transition from the state causing deflection to the state causing no deflection, like the liquid crystal light deflector 100 according to Embodiment 1. The liquid crystal light deflector 100 according to the embodiment can avoid disrupted alignment of the liquid crystals 60, and thus prevent the non-uniform optical properties of the liquid-crystal light deflection panel 10, in a transition of the liquid-crystal light deflection panel 10 from the state causing deflection to the state causing no deflection. The liquid crystal light deflector 100 according to the embodiment can achieve a simpler electrode configuration of the liquid-crystal light deflection panel 10 and a simpler configuration of the controller 90.

### Modifications

The above-described embodiments may be modified in various manners within the gist of the present disclosure.

For example, the second electrode 50 in Embodiment 1 is a single rectangular electrode. The second electrode 50 may be replaced with multiple linear electrodes opposed to the first electrodes 40 and extending in the Y direction.

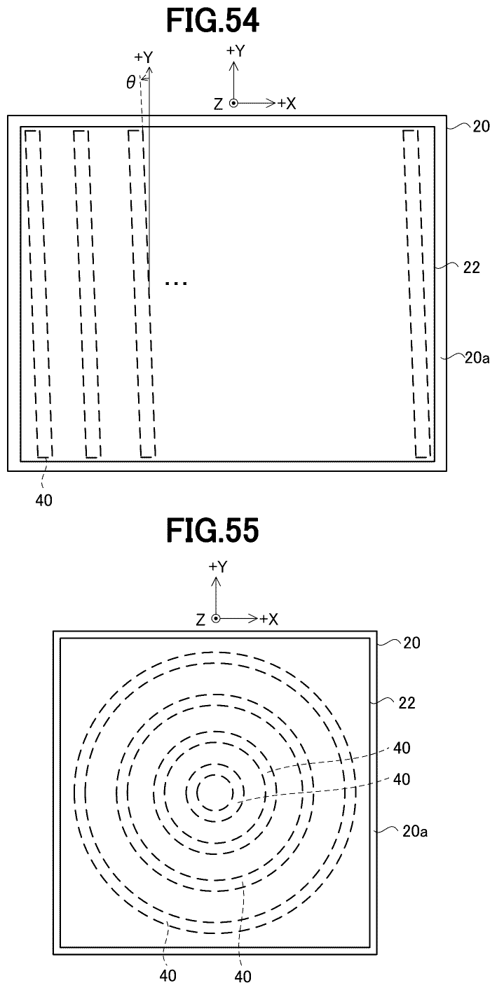

In Embodiment 1, the liquid crystals 60 in the initial alignment state are aligned in the Y direction, and the first electrodes 40 extend in the Y direction. That is, the first electrodes 40 extend in the direction parallel to the initial alignment direction of the liquid crystals 60. Alternatively, the first electrodes 40 may extend in a direction different from the initial alignment direction of the liquid crystals 60. For example, as illustrated in FIG. 54, the first electrodes 40 in Embodiment 1 may have a counterclockwise inclination from the +Y direction by an angle θ. The liquid-crystal light deflection panel 10 in this modification serves as a lenticular lens array having lenticular lens elements inclined from the Y direction by an angle θ.

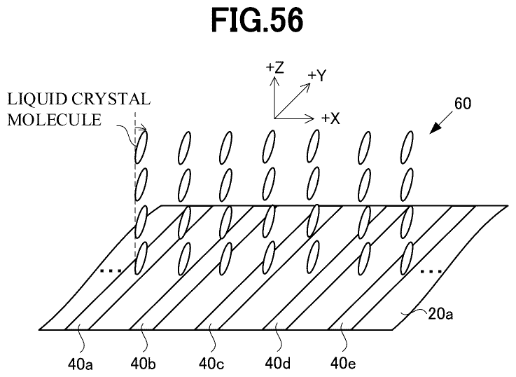

The first electrodes 40, the one or more second electrodes 50, and the electrodes 80, which have a linear or rectangular shape in the above-described embodiments, may have any shape. For example, the first electrodes 40 mounted on the first substrate 20 may be annular electrodes concentrically arranged as illustrated in FIG. 55, and the second electrode 50 mounted on the second substrate 30 may have a rectangular shape as in Embodiment 1. The liquid-crystal light deflection panel 10 in this modification serves as a convex lens or concave lens.

Although the first electrodes 40 or the electrodes 80 are mounted on the first substrate 20 and the one or more second electrodes 50 are mounted on the second substrate 30 in the above-described embodiments, this arrangement of the first electrodes 40, the second electrodes 50, and the electrodes 80 is a mere example. For example, the first electrodes 40 or the electrodes 80 may be mounted on the second substrate 30, and the one or more second electrodes 50 may be mounted on the first substrate 20.

Only at least some of the liquid crystals 60 are required to be driven toward the direction orthogonal to the initial alignment direction, in a transition of the liquid-crystal light deflection panel 10 from the first state to the second state. In the second state, the liquid crystals 60 do not need to be uniformly aligned in the direction orthogonal to the initial alignment direction. For example, in the second state of the liquid-crystal light deflection panel 10 in Embodiment 1, the liquid crystals 60 may be uniformly aligned in a direction inclined from the +Z direction, as illustrated in FIG. 56.

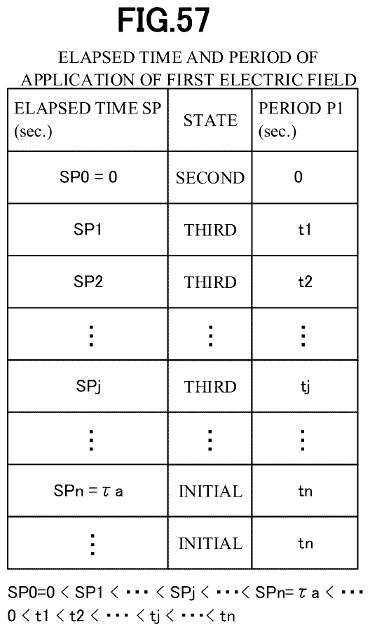

In Embodiment 9, the controller 90 applies the first electric field having an intensity varying depending on the elapsed time SP to the liquid crystals 60 for the predetermined period, and then applies the predetermined electric field to the liquid crystals 60. Alternatively, the controller 90 may refer to a lookup table (FIG. 57) in which the period P1 of application of the first electric field to the liquid crystals 60 varies depending on the elapsed time SP. Specifically, when the elapsed time SP is shorter than the completion time ta required for completion of a transition of the liquid-crystal light deflection panel 10 to the initial state, the controller 90 sets a longer period P1 of application of the first electric field as the elapsed time SP extends. When the elapsed time SP is the completion time ta or longer, the controller 90 sets a constant period P1 of application of the first electric field regardless of the elapsed time SP. For example, the controller 90 sets a longer period P1 of application of the first electric field as the elapsed time SP extends from the time SP1 to the time SPn, on the basis of the lookup table illustrated in FIG. 57. When the elapsed time SP is equal to or longer than the time SPn, the controller 90 sets a constant period P1 of application of the first electric field regardless of the elapsed time SP (P1=tn). This configuration can achieve appropriate overdrive control of the liquid-crystal light deflection panel 10 in the initial state or third state, as in Embodiment 9. The length of the period P1 is determined in advance on the basis of examinations or simulations, so as to achieve a shorter response time τon without excessive driving of the liquid crystals 60.

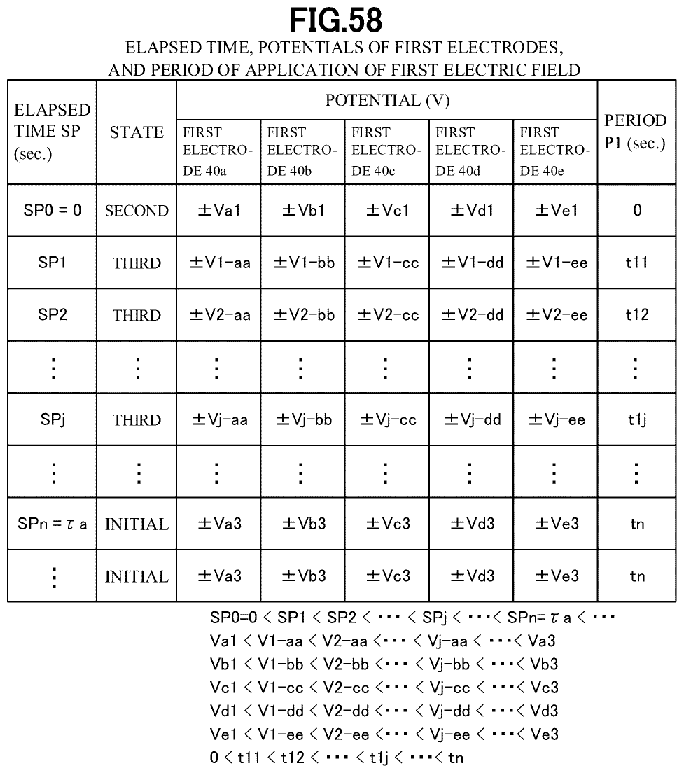

Alternatively, the controller 90 may refer to a lookup table (FIG. 58) in which the intensity of the first electric field and the period (period P1) of application of the first electric field vary depending on the elapsed time SP. Specifically, when the elapsed time SP is shorter than the completion time ta required for completion of a transition of the liquid-crystal light deflection panel 10 to the initial state, the controller 90 sets a higher intensity of the first electric field and a longer period P1 of application of the first electric field as the elapsed time SP extends. When the elapsed time SP is the completion time ta or longer, the controller 90 sets a constant intensity of the first electric field and a constant period P1 of application of the first electric field regardless of the elapsed time SP. For example, the controller 90 sets larger absolute values of electric potentials of the individual first electrodes 40a to 40e illustrated in FIG. 8 and a longer period P1 of application of the first electric field, as the elapsed time SP extends from the time SP1 to the time SPn, on the basis of the lookup table illustrated in FIG. 58. When the elapsed time SP is equal to or longer than the time SPn, the controller 90 sets a constant intensity of the first electric field and a constant period P1 of application of the first electric field, regardless of the elapsed time SP. This configuration can achieve appropriate overdrive control of the liquid-crystal light deflection panel 10 in the initial state or third state, as in Embodiment 9. The intensity of the first electric field (electric potentials of the first electrodes) and the length of the period P1 are determined in advance on the basis of examinations or simulations, so as to achieve a shorter response time τon without excessive driving of the liquid crystals 60.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A liquid crystal light deflector, comprising:
a liquid-crystal light deflection panel including
a first substrate through which light enters,
a second substrate opposed to the first substrate,
liquid crystals held between the first substrate and the second substrate, and
electrodes to apply an electric field to the liquid crystals; and
a controller to control deflection of the light by the liquid-crystal light deflection panel, wherein
the controller applies a predetermined electric field to the liquid crystals and thus causes the liquid-crystal light deflection panel to transition to a first state causing the deflection, the predetermined electric field driving the liquid crystals toward a direction orthogonal to an initial alignment direction of the liquid crystals, the predetermined electric field generating a distribution of refractive indexes in the liquid crystals in accordance with levels of the deflection, and
the controller applies a uniform electric field to the liquid crystals and thus causes the liquid-crystal light deflection panel to transition from the first state to a second state causing no deflection, the uniform electric field driving at least some of the liquid crystals toward the direction orthogonal to the initial alignment direction.

2. The liquid crystal light deflector according to claim 1, wherein the controller stops application of the uniform electric field to the liquid crystals, and thus causes the liquid-crystal light deflection panel to transition from the second state to an initial state causing no deflection, the liquid crystals being in an initial alignment state in the initial state.

3. The liquid crystal light deflector according to claim 2, wherein in order to cause the liquid-crystal light deflection panel to transition from the initial state to the first state, the controller applies a first electric field to the liquid crystals and then applies the predetermined electric field to the liquid crystals, the first electric field driving the liquid crystals toward the direction orthogonal to the initial alignment direction of the liquid crystals, the first electric field varying depending on the distribution of refractive indexes, the first electric field being higher than the predetermined electric field.

4. The liquid crystal light deflector according to claim 3, wherein in order to cause the liquid-crystal light deflection panel to transition from a third state to the first state, the controller applies the predetermined electric field to the liquid crystals without applying the first electric field, the third state being in a middle of transition from the second state to the initial state.

5. The liquid crystal light deflector according to claim 2, wherein
in order to cause the liquid-crystal light deflection panel to transition from the initial state or a third state to the first state, the controller applies a first electric field to the liquid crystals and then applies the predetermined electric field to the liquid crystals, the first electric field driving the liquid crystals toward the direction orthogonal to the initial alignment direction of the liquid crystals, the first electric field varying depending on the distribution of refractive indexes, the first electric field being higher than the predetermined electric field, the third state being in a middle of transition from the second state to the initial state, and
at least one of an intensity of the first electric field applied to the liquid crystals or a period of application of the first electric field to the liquid crystals varies depending on an elapsed time since stop of application of the uniform electric field to the liquid crystals.

6. The liquid crystal light deflector according to claim 1, wherein the electrodes include first electrodes and a second electrode opposed to the first electrodes.

7. The liquid crystal light deflector according to claim 6, wherein the first electrodes are each a linear electrode extending in a predetermined direction.

8. The liquid crystal light deflector according to claim 6, wherein the first electrodes have an annular shape and are concentrically arranged.

9. The liquid crystal light deflector according to claim 1, wherein the electrodes include
first electrodes mounted on one of the first substrate or the second substrate and extending in a predetermined first direction, and
second electrodes mounted on another of the first substrate or the second substrate and extending in a second direction intersecting the predetermined first direction.

10. The liquid crystal light deflector according to claim 1, wherein
the electrodes are mounted on one of the first substrate or the second substrate, and
the electrodes are each a linear electrode extending in a predetermined direction.

11. A driving method of a liquid crystal light deflector, the driving method comprising:
applying a predetermined electric field to liquid crystals of a liquid-crystal light deflection panel and thus causing the liquid-crystal light deflection panel to transition to a first state causing deflection, the predetermined electric field driving the liquid crystals toward a direction orthogonal to an initial alignment direction of the liquid crystals, the predetermined electric field generating a distribution of refractive indexes in the liquid crystals in accordance with levels of the deflection; and
applying a uniform electric field to the liquid crystals and thus causing the liquid-crystal light deflection panel to transition from the first state to a second state causing no deflection, the uniform electric field driving at least some of the liquid crystals toward the direction orthogonal to the initial alignment direction.
